(19) United States
(12) Patent Application Publication
(10) Pub. No.: US 2017/0190070 A1
(43) Pub. Date: Jul. 6, 2017

(54) CUTTING DATA CREATION METHOD, CUTTING DATA CREATION DEVICE, AND COMPUTER-READABLE RECORDING MEDIUM

(71) Applicant: BROTHER KOGYO KABUSHIKI KAISHA, Nagoya (JP)

(72) Inventor: Satomi Yamamoto, Nagoya (JP)

(21) Appl. No.: 15/467,808

(22) Filed: Mar. 23, 2017

Related U.S. Application Data
(63) Continuation of application No. PCT/JP2016/054707, filed on Feb. 18, 2016.

(30) Foreign Application Priority Data
Feb. 26, 2015 (JP) 2015-036652

(51) Int. Cl. B26D 5/00; G05B 19/18; G05B 19/23; B26D 7/26; B26F 1/44

(52) U.S. Cl. CPC B26D 5/005; B26D 7/2614; B26F 1/44; G05B 19/23; G05B 19/182; G05B 2219/45038

(57) ABSTRACT

A cutting data creation device for creating data for fabricating a decoration representing an entire pattern formed by combination of a plurality of partial patterns demarcated by borders by folding, in layers, a sheet cut in a shape having the linked partial patterns so the sheet is partitioned into units demarcated by the borders, the device includes a controller to control the device to: set a lap line for laying a part of the border of one of the partial patterns and a part of the border of an another partial patterns on top of each other, for each of the two partial patterns; join the border of the one partial pattern and the border of the different partial pattern in a shape having the borders linked at the lap lines set by setting; and create data for cutting along the borders linked by the joining, except the lap lines.

### CROSS-REFERENCE TO RELATED APPLICATION

This application is a continuation application of International Application No. PCT/JP2016/054707, filed on Feb. 18, 2016, which claims priority from Japanese Patent Application No. 2015-036652, filed on Feb. 26, 2015. The disclosure of the foregoing application is hereby incorporated by reference in its entirety.

### FIELD

The present disclosure relates to a cutting data creation method, a cutting data creation device, and a computer-readable recording medium pertaining to cutting data for cutting a sheet as a cutting object to fabricate a decoration composed of the folded sheet.

### BACKGROUND

A cutting device which automatically cuts an object to be cut such as a sheet of paper has been conventionally known.

A conventional cutting device includes a display. A user selects a desired pattern from among a plurality of patterns displayed on the display. The above-described sheet is attached to a holding member having an adhesive layer on an obverse face thereof. The cutting device vertically pinches two end parts of the holding member between a drive roller of a drive mechanism and a pinch roller to move the holding member in a first direction, and moves a carriage including a cutter in a second direction orthogonal to the first direction. With this operation, the sheet is cut along an outline of the selected pattern.

### SUMMARY

To fabricate a decoration composed of a plurality of sheets laid on top of one another, a partial pattern cut out from a different sheet is first laid on and attached to a sheet serving as a base (a base sheet). A partial pattern in a different shape cut out from a still different sheet is laid on and attached to the partial pattern. In this manner, the decoration representing a convex or concave entire pattern which is a combination of the plurality of partial patterns can be fabricated.

Although the conventional cutting device can cut out a desired pattern from one sheet, the conventional cutting device cannot fabricate the above-described decoration. To fabricate the decoration, the user needs to manually cut out partial patterns from sheets using, for example, scissors and does not use a cutting device. Specifically, the user has no choice but to fabricate the decoration by determining the shapes, the sizes, and the layout of partial patterns to be cut out from sheets while imaging the entire pattern. Arrangement of such sheets (partial patterns), and the like take much effort.

An object of the present disclosure is to provide a cutting data creation method, a cutting data creation device, and a computer-readable recording medium which are capable of easily fabricating a desired decoration representing an entire pattern which is a combination of partial patterns by folding a sheet as an object to be cut in layers.

In order to attain the above-described object, a cutting data creation method according to the present disclosure is a cutting data creation method for creating cutting data for fabricating a decoration representing an entire pattern formed of a combination of a plurality of partial patterns demarcated by borders by folding, in layers, a sheet cut in a shape having the linked partial patterns such that the sheet is partitioned into units demarcated by the borders, the cutting data creation method including: setting a lap line for laying a part of the border of one of the partial patterns and a part of the border of a different one of the partial patterns on top of each other, for each of the two partial patterns; joining the border of the one partial pattern and the border of the different partial pattern in a shape having the borders linked at the lap lines set in the setting; and creating cutting data for cutting along the borders linked in the joining, except the lap lines.

A cutting data creation device according to the present disclosure is a cutting data creation device for creating cutting data for fabricating a decoration representing an entire pattern formed of a combination of a plurality of partial patterns demarcated by borders by folding, in layers, a sheet cut in a shape having the linked partial patterns such that the sheet is partitioned into units demarcated by the borders, the cutting data creation device comprising: a controller, the controller being configured to control the cutting data creation device to: set a lap line for laying a part of the border of one of the partial patterns and a part of the border of a different one of the partial patterns on top of each other, for each of the two partial patterns; join the border of the one partial pattern and the border of the different partial pattern in a shape having the borders linked at the lap lines set by setting; and create cutting data for cutting along the borders linked by the joining, except the lap lines.

A computer-readable recording medium according to the present disclosure is a computer-readable recording medium having recorded thereon a program for causing a computer to function as various processing sections of the cutting data creation device according to the above-described exemplary aspect.

This summary is not intended to identify critical or essential features of the disclosure, but instead merely summarizes certain features and variations thereof. Other details and features will be described in the sections that follow.

### BRIEF DESCRIPTION OF THE DRAWINGS

Aspects of the disclosure are illustrated by way of example, and not by limitation, in the accompanying figures in which like reference characters may indicate similar elements.

FIG. 1 is an overall perspective view showing a cutting data creation device and a cutting device connected to each other, according to a first exemplary embodiment;

FIG. 2 is a block diagram showing an electrical configuration;

FIG. 3A is a front view of a decoration representing an entire pattern;

FIG. 3B is a plan view of a sheet before being folded in layers;

FIG. 3C is an explanatory view showing the sheet folded in layers while units demarcated by borders are shifted from one another;

FIG. 4A is an explanatory view of a cutting line for a partial pattern (No. 1);

FIG. 4B is an explanatory view of a cutting line for a partial pattern (No. 2);

FIG. 4C is an explanatory view of a cutting line for a partial pattern (No. 3);

FIG. 4D is an explanatory view of a cutting line for a partial pattern (No. 4);

FIG. 5 is an explanatory diagram of the structure of cutting data;

FIG. 6 are views showing a process of generating cutting data (No. 1) and layers;

FIG. 7 are views showing a process of generating cutting data (No. 2) and lap lines;

FIG. 8 is a flowchart showing the flow of an overall process of a cutting data creation program;

FIG. 9 is a flowchart of an overlapping order decision process;

FIG. 10 is a flowchart of a partial pattern inclusion information acquisition process;

FIG. 11 is a flowchart of a partial pattern overlapping order rearrangement process;

FIG. 12 is a flowchart of a cutting-data-for-folding creation process;

FIG. 13 is a flowchart of a fold line cutting data creation process;

FIG. 14A is a front view of a decoration according to a second exemplary embodiment;

FIG. 14B is a plan view of a sheet with a border joining direction set to a Y-axis negative direction;

FIG. 14C is a plan view of a sheet with a border joining direction set to a Y-axis positive direction;

FIG. 14D is a plan view of a sheet with a border joining direction set to an X-axis positive direction;

FIG. 14E is a plan view of a sheet with a border joining direction set to an X-axis negative direction;

FIG. 15 is a view corresponding to FIG. 14C and showing a configuration provided with a holding unit, according to a third exemplary embodiment;

FIG. 16A is a front view of a decoration according to a fourth exemplary embodiment; and

FIG. 16B is a plan view of a sheet before being folded in layers.

### DETAILED DESCRIPTION

For a more complete understanding of the present disclosure, needs satisfied thereby, and the objects, features, and advantages thereof, reference now is made to the following descriptions taken in connection with the accompanying drawings. Hereinafter, illustrative embodiments will be described with reference to the accompanying drawings.

### First Exemplary Embodiment

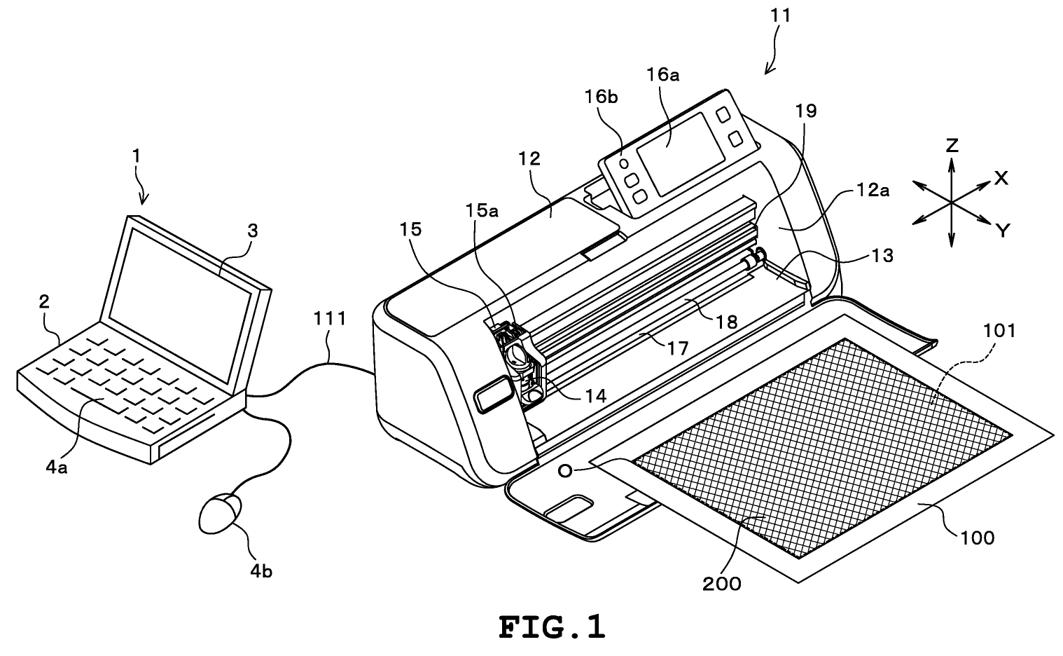

A first exemplary embodiment of the present disclosure will be described below with reference to the drawings. FIG. 1 shows a cutting data creation device 1 and a cutting device 11. The cutting data creation device 1 and the cutting device 11 are connected to each other by a communication cable 111.

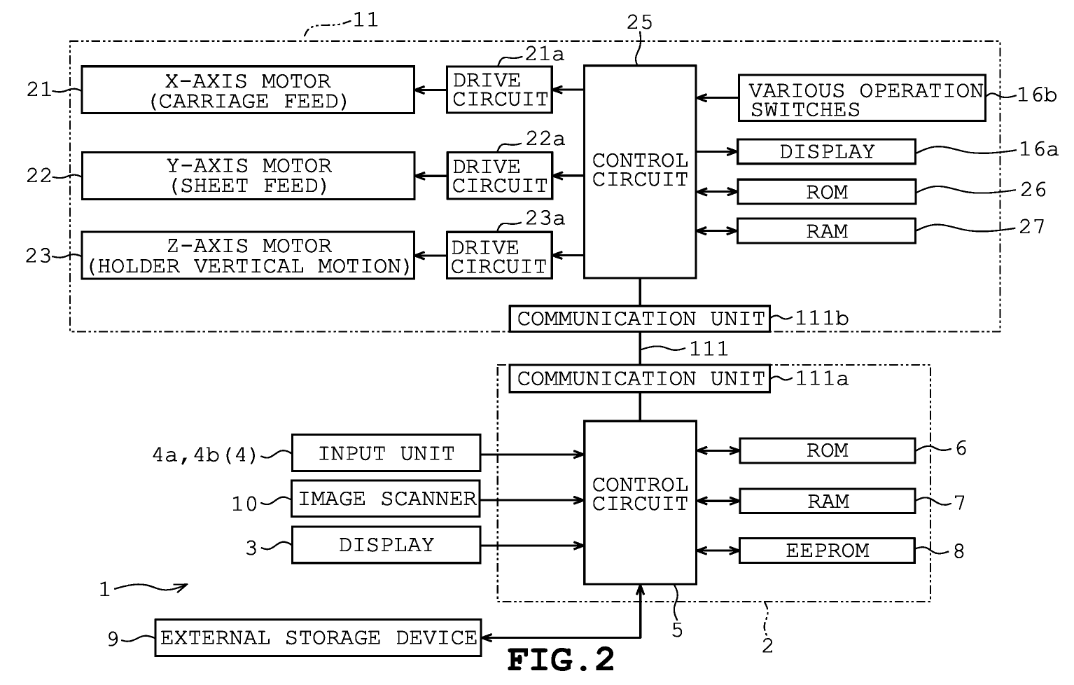

The cutting data creation device 1 is composed of, for example, a general-purpose personal computer (PC). Specifically, the cutting data creation device 1 includes a creation device body unit 2 which is composed of a personal computer body, a display unit (hereinafter referred to as a display 3) which is composed of, for example, a color liquid crystal display, and an input unit 4 which is composed of a keyboard 4a and a mouse 4b. The cutting data creation device 1 also includes an image scanner 10 (shown only in FIG. 2) which is capable of reading a color image.

As shown in FIG. 2, a control circuit 5 of the creation device body unit 2 is composed mainly of a computer (CPU) and is connected to a ROM 6, a RAM 7, and an EEPROM 8. The control circuit 5 is also connected to the input unit 4 composed of the keyboard 4a and the mouse 4b, the display 3, the image scanner 10, and an external storage device 9 which is attachable/detachable to/from the creation device body unit 2. The EEPROM 8 or the external storage device 9 stores a cutting data creation program (to be described later). During execution of the cutting data creation program, various patterns and necessary information are displayed on the display 3. At this time, a user operates the keyboard 4a and the mouse 4b to make necessary entries and give necessary instructions, thereby allowing the cutting data creation device 1 to create cutting data.

The cutting data creation device 1 also includes a communication unit 111a. The communication unit 111a is connected to a communication unit 111b of the cutting device 11 via the communication cable 111. This configuration enables transmission and reception of data including cutting data between the cutting data creation device 1 and the cutting device 11. Note that the communication unit 111a of the cutting data creation device 1 and the communication unit 111b of the cutting device 11 may be connected wirelessly, instead of being connected by wires.

The cutting device 11 cuts a sheet material 200 as a cutting object on the basis of cutting data. As shown in FIG. 1, the cutting device 11 includes a body cover 12 as a housing, a platen 13 which is disposed inside the body cover 12, a carriage 15 which is equipped with a cutter cartridge 14, and a holding member 100 for holding the sheet material 200. The holding member 100 is formed in the shape of a rectangular flat plate and has an adhesive layer 101 (indicated by a dashed line in FIG. 1) on an obverse face thereof. The holding member 100 holds the sheet material 200 attached to the adhesive layer 101 and is set so as to be placed on the generally horizontal platen 13.

The body cover 12 has the shape of a horizontally long rectangular box, and a side with an opening part 12a at the front of the body cover 12 is set as a front side of the cutting device 11. In the following description, a front-back direction, in which the holding member 100 is to be transferred on the platen 13, is referred to as a Y-direction, and a left-right direction orthogonal to the Y-direction is referred to as an X-direction. A vertical direction orthogonal to the platen 13 is referred to as a Z-direction.

A display 16a and various operation switches 16b are provided at an upper right part of the body cover 12. The display 16a is composed of, for example, a color liquid crystal display and displays a necessary message and the like to the user. The various operation switches 16b are used to perform operations, such as making various selections and giving various instructions for cutting data (to be described later).

A machine casing (not shown) inside the body cover 12 is provided with a drive roller 17 and a pinch roller 18 which extend in the left-right direction. The drive roller 17 and the pinch roller 18 vertically pinch two end parts of the holding member 100 that is set on the platen 13. A Y-axis motor 22 (see FIG. 2) and a Y-axis movement mechanism (not shown) are provided inside the body cover 12. The Y-axis movement mechanism transmits a rotational motion of the Y-axis motor 22 to the drive roller 17, thereby moving the holding member 100 in the Y-direction together with the sheet material 200.

The machine casing inside the body cover 12 is provided with an X-axis guide rail 19 which guides the carriage 15 in the X-direction. An X-axis motor 21 (see FIG. 2) and an X-axis movement mechanism (not shown) are provided inside the body cover 12. The X-axis movement mechanism moves the carriage 15 in the X-direction along the X-axis guide rail 19 with the aid of rotation of the X-axis motor 21.

A cartridge holder 15a is provided on the front side of the carriage 15. The cutter cartridge 14 is detachably mounted to the cartridge holder 15a. A Z-axis motor 23 (see FIG. 2) and a Z-axis movement mechanism (not shown) are provided inside the carriage 15. The Z-axis movement mechanism moves the cartridge holder 15a in the Z-direction together with the cutter cartridge 14 with the aid of rotation of the Z-axis motor 23.

Although not shown in detail, when the cartridge holder 15a is moved downward by the Z-axis movement mechanism, a blade edge of a cutter which is provided at a lower end of the cutter cartridge 14 penetrates through the sheet material 200 held by the holding member 100. In this state, the cutting device 11 moves the holding member 100 in the Y-direction via the Y-axis movement mechanism with the aid of driving by the Y-axis motor 22 and moves the carriage 15 in the X-direction via the X-axis movement mechanism with the aid of driving by the X-axis motor 21, thereby executing a cutting operation on the sheet material 200. Thus, the X-axis movement mechanism, the Y-axis movement mechanism, and the Z-axis movement mechanism and the corresponding motors 21, 22, and 23 function as a relative movement section which moves the cutter of the cutter cartridge 14 and the sheet material 200 held by the holding member 100 relatively to each other. The relative movement section together with the cutter cartridge 14 constitutes a cutting section.

Note that, for example, an XY coordinate system, in which a left corner of the adhesive layer 101 on the holding member 100 shown in FIG. 1 is set as an origin O, is set in the cutting device 11 and that the holding member 100 and the cutter cartridge 14 are moved relatively to each other on the basis of the XY coordinate system. In the cutting device 11, a pen cartridge (not shown) is prepared as a printing section, in addition to the cutter cartridge 14. Thus, selecting one from among such cartridges and mounting the cartridge to the cartridge holder 15a allows execution of a cutting operation or a printing operation on the sheet material 200. Note that a configuration similar to that of Japanese Patent Laid-Open No. 2014-124748 filed by the applicant of the present disclosure can be adopted as the detailed configuration of the cutting device 11 and that a description thereof will be omitted.

As shown in FIG. 2, a control circuit 25 of the cutting device 11 is composed mainly of a computer (CPU) and is connected to a ROM 26, a RAM 27, and the communication unit 111b. The ROM 26 stores a control program for controlling a cutting operation (or a printing operation) and the like. The control circuit 25 acquires cutting data created by the cutting data creation device 1 via the communication unit 111b (the communication cable 111).

The control circuit 25 is connected to the display 16a and the various operation switches 16b and is also connected to drive circuits 21a, 22a, and 23a which drive the X-axis motor 21, the Y-axis motor 22, and the Z-axis motor 23, respectively. The control circuit 25 controls the X-axis motor 21, the Y-axis motor 22, the Z-axis motor 23, and the like on the basis of cutting data to automatically execute a cutting operation on the sheet material 200 held by the holding member 100.

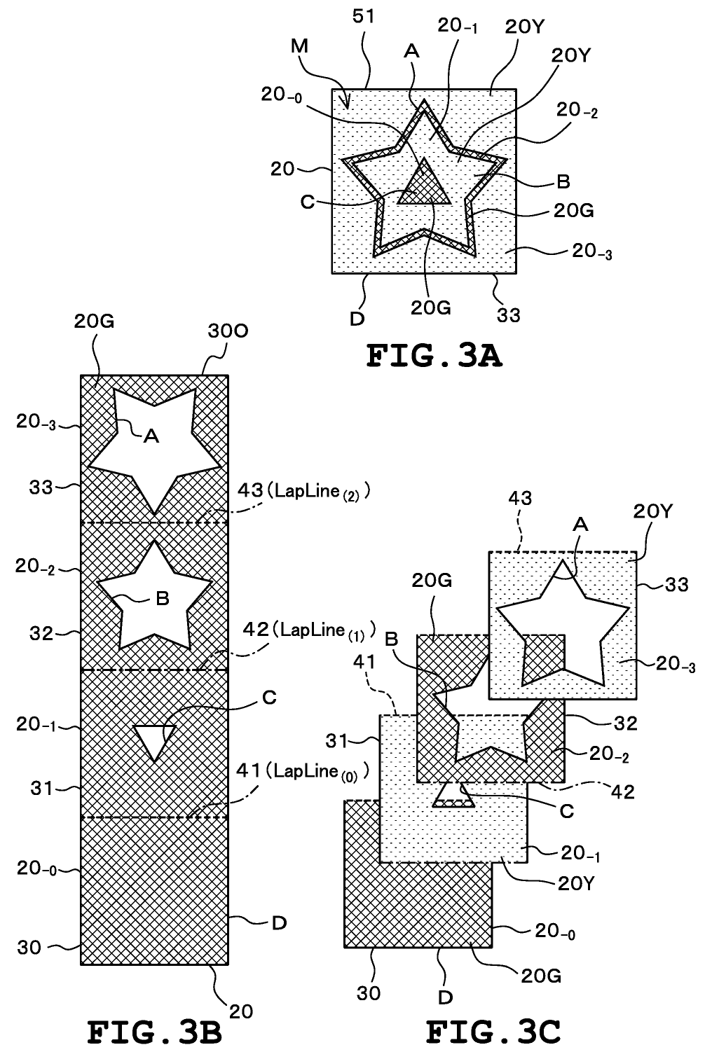

A decoration 51 shown in FIG. 3A is fabricated by folding, in layers, one sheet piece (sheet) 20 which is cut out from the sheet material 200 by the cutting device 11 in a zigzag (like an accordion). The decoration 51 represents “star” figures and a “triangle” figure at the center of the figures. FIG. 3B shows a state in which the sheet piece 20 is not folded, i.e., the sheet piece 20 is unfolded so as to illustrate that the decoration 51 is formed by folding, in layers, the one sheet piece 20 in a zigzag. FIG. 3C shows a state in which the sheet piece 20 is divided into parts at positions of fold lines 41 to 43 and the parts are shifted from one another for sake of convenience so as to illustrate that the figures have a concave shape.

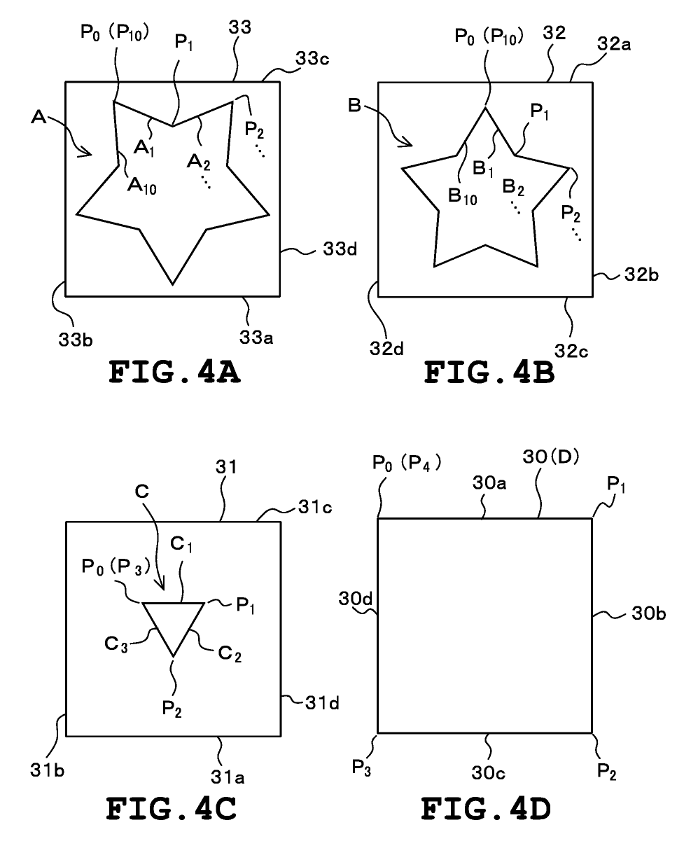

Among the figures represented by the decoration 51 in FIG. 3A, a “star” is referred to as a first partial pattern A, and a small “star” inside the first partial pattern A is referred to as a second partial pattern B. A “triangle” inside the second partial pattern B is referred to as a third partial pattern C. A square part constituting a frame pattern, i.e., a “peripheral area” (the background) of the decoration 51 is referred to as a fourth partial pattern D. The sheet piece 20 constituting the decoration 51 has a belt shape extending in a development direction in a developed state as shown in FIG. 3B. A contour of the entire sheet piece 20 in the state is a border 300 which is obtained by linking, in the development direction, four borders 30 to 33 (see FIG. 4) which demarcate units of folding of the sheet piece 20.

That is, the border 300 is formed by joining, in the development direction, the four borders 30, 31, 32, and 33 that divide the sheet piece 20 into four sheet parts 20₋₀, 20₋₁, 20₋₂, and 20₋₃. Of the four borders, the border 30 demarcates a region for the base sheet part 20₋₀ representing an outline of the fourth partial pattern D, and the borders 31, 32, and 33 demarcate respective peripheral regions outside the first, second, and third partial patterns A, B, and C (see FIG. 3C). All of the borders 30 to 33 in the present exemplary embodiment are, for example, squares having the same dimensions and the same shape. The border 30 corresponds to the outline of the fourth partial pattern D. As described above, the sheet piece 20 has a shape having the four partial patterns A to D linked via the “surrounding” borders 30 to 33.

The sheet piece 20 that is cut along outlines of the partial patterns A to C and the border 300 for the whole is folded in layers in a zigzag such that the sheet piece 20 is partitioned into the sheet parts 20₋₀ to 20₋₃. With this folding, an entire pattern M shown in FIG. 3A formed of a combination of patterns of “stars” and a “triangle” formed by the partial patterns A, B, and C and the partial pattern D of a “peripheral area” is represented.

As shown in the exploded view in FIG. 3C, in the decoration 51 in this state, the sheet part 20₋₁ with the third partial pattern C cut out, the sheet part 20₋₂ with the second partial pattern B cut out, and the sheet part 20₋₃ with the first partial pattern A cut out are folded and laid in that order in front of the base sheet part 20₋₀ to represent “stars” and a “triangle” with a concave shape. In this case, if the sheet piece 20 is, for example, a double-sided colored sheet of paper having a green obverse face 20G and a yellow reverse face 20Y, the decoration 51 is represented in two colors, green of the obverse faces 20G of the sheet parts 20₋₀ and 20₋₂ and yellow of the reverse faces 20Y of the sheet parts 20₋₁ and 20₋₃ that are reversed at the time of folding. The valley fold line 41, the mountain fold line 42, and the valley fold line 43 that are cutting lines indicating fold line positions for a zigzag fold described above are formed in that order at the sheet piece 20. The valley fold lines 41 and 43 indicate that the sheet piece 20 is to be valley-folded at the valley fold lines 41 and 43. The mountain fold line 42 indicates that the sheet piece 20 is to be mountain-folded at the mountain fold line 42. The fold lines 41 to 43 are cutting lines of perforation. For example, the valley fold lines 41 and 43 are formed as dashed cutting lines while the mountain fold line 42 is formed as an alternate long and short dash cutting line. Note that the types (line types) of a valley fold line and a mountain fold line are not limited to the above-described ones.

Hereinafter, cutting data for cutting the sheet material 200 to fabricate the decoration 51 is referred to as “cutting data for folding.” Note that the sheet parts 20₋₁ to 20₋₃ that are laid in front of the base sheet part 20₋₀ when the sheet piece 20 is folded in layers are referred to as first, second, and third sheet parts, respectively, in order from the base sheet part 20₋₀. The numbers “₋₀”, “₋₁”, “₋₂”, and “₋₃” added to the end of reference numeral 20 in FIG. 3A to 3C and the like indicate the base sheet part, the first sheet part, the second sheet part, and the third sheet part, respectively. The symbols “G” and “Y” added to the end of, e.g., reference numeral 20 denoting a sheet piece in FIG. 3A to 3C correspond to the colors of the obverse and reverse faces of the sheet piece 20. The symbol “G” represents green while the symbol “Y” represents yellow. For convenience of explanation, the first partial pattern A to the fourth partial pattern D are hereinafter simply referred to as the “partial pattern A” to the “partial pattern D,” respectively.

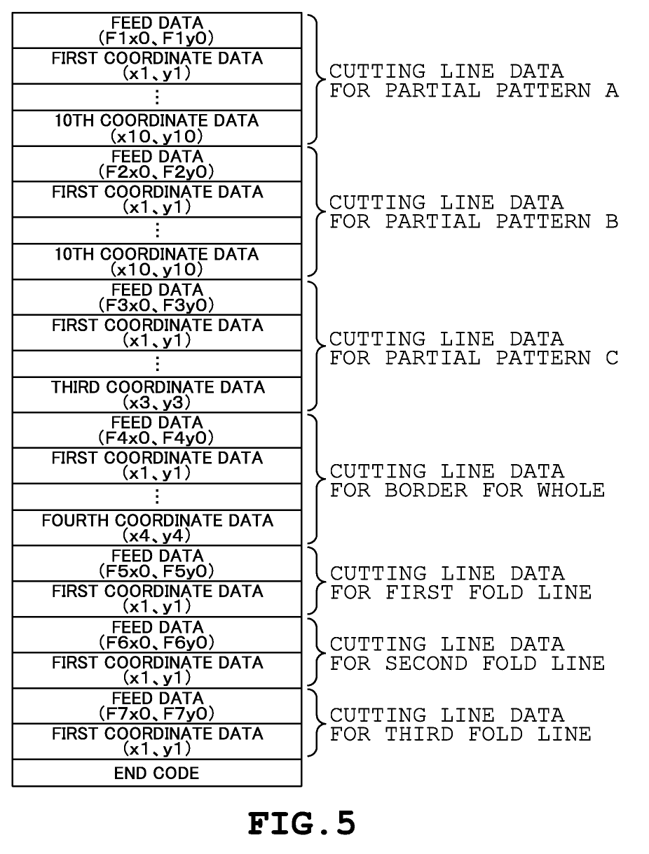

As shown in FIG. 5, the above-described cutting data for folding includes feed data, coordinate data, an end code, and data for display (not shown) for sequentially cutting along the partial patterns A to C, the border 300, and marks of folding (fold lines).

The coordinate data is defined by the XY coordinate system of the cutting device 11, and two sets of “first coordinate data (x1, y1) . . . 10th coordinate data (x10, y10)” shown on the upper side in FIG. 5 represent coordinate values for cutting along cutting lines of the partial patterns A and B.

The cutting line of the partial pattern A in FIG. 4A has a figure similar to that of the partial pattern B in FIG. 4B and is set to have an orientation which is a 180-degree reversal of that of the partial pattern B (an orientation corresponding to a “symmetrical shape” (to be described later)). The cutting line of the partial pattern A has the shape of a “star” which has 10 line segments A₁, A₂, . . . , A₁₀ as an outline. Cutting line data for the partial pattern A includes feed data (F1x0, F1y0) and first coordinate data (x1, y1), . . . , 10th coordinate data (x10, y10) corresponding to a cutting start point P₀, a point P₁, . . . , a cutting end point P₁₀. The feed data is data for moving the cutter of the cutting device 11 to the cutting start point P₀ at the start of cutting. That is, movement of the carriage 15 to the cutting start point P₀ and vertical motion of the cutter at the time of feeding without cutting are carried out on the basis of the feed data.

The cutting line of the partial pattern B in FIG. 4B has the shape of a “star” which has 10 line segments B₁, B₂, . . . , B₁₀ as an outline. Cutting line data for the partial pattern B includes feed data (F2x0, F2y0) and first coordinate data (x1, y1), . . . , 10th coordinate data (x10, y10) corresponding to a cutting start point P₀, a point P₁, . . . , a cutting end point P₁₀, respectively.

A cutting line of the partial pattern C in FIG. 4C has the shape of a “triangle” which has three line segments C₁, C₂, and C₃ as an outline. The cutting line of the partial pattern C is set to have an orientation corresponding to a “symmetrical shape”, as in the case of the partial pattern A. Cutting line data for the partial pattern C includes feed data (F3x0, F3y0) and first coordinate data (x1, y1), second coordinate data (x2, y2), and third coordinate data (x3, y3) corresponding to a cutting start point P₀, a point P₁, a point P₂, and a cutting end point P₃, respectively.

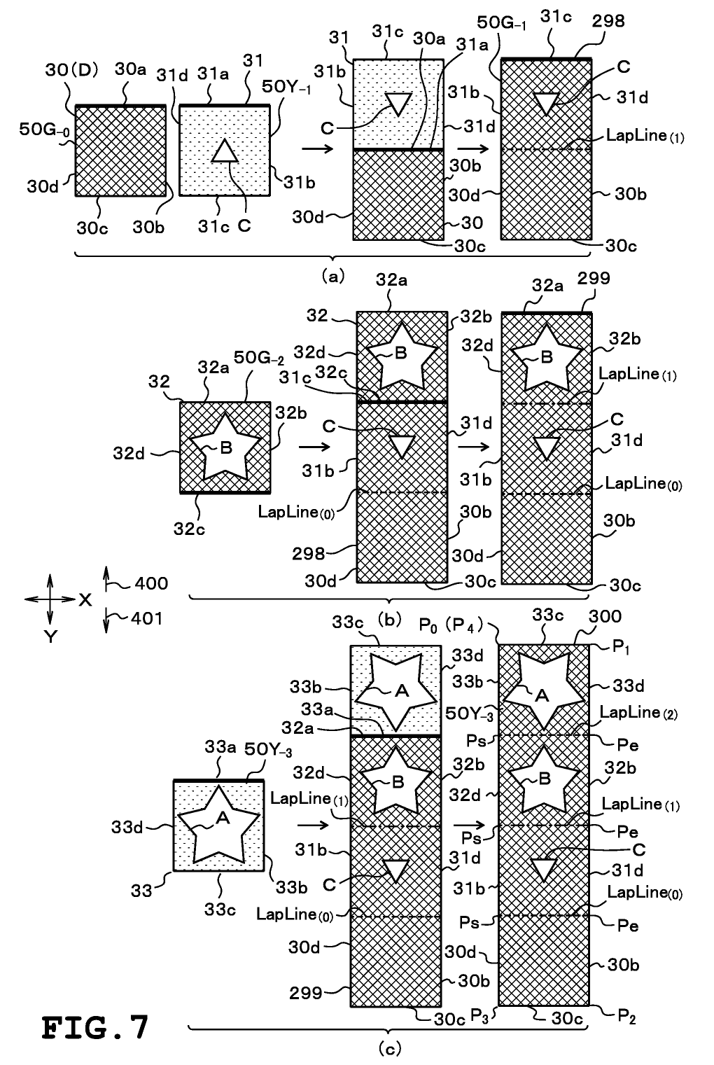

The partial pattern D in FIG. 4D has a square outline constituting a “peripheral area”. As described earlier, as for the partial pattern D, a shape having a plurality of linked partial patterns D is cut out, i.e., cutting along the border 300 for the whole is performed. Of the border 30 of the base sheet part 20₋₀, line segments 30b, 30c, and 30d (see FIG. 4D and portion (c) of FIG. 7) serve as a cutting line. Cutting line data for the border 300 includes feed data (F4x0, F4y0) and first coordinate data (x1, y1), . . . , fourth coordinate data (x4, y4) corresponding to a cutting start point P₀, a point P₁, . . . , a cutting end point P₄ respectively (see FIG. 5 and portion (c) of FIG. 7).

Cutting line data for first, second, and third fold lines shown on the lower side of FIG. 5 correspond to the valley fold line 41, the mountain fold line 42, and the valley fold line 43, respectively. Cutting line data for each of the fold lines 41 to 43 includes feed data (F4x0, F4y0) or the like, coordinate data (x1, y1), and an attribute flag (not shown) for a cutting line of perforation. The attribute flag is data to be added for distinction between a normal cutting line for cutting along the partial patterns A to C and the border 300 and a cutting line of perforation for the fold lines 41 to 43. Note that a cutting line of perforation is formed by the control circuit 25 controlling the cutter to intermittently perform vertical motion in accordance with the types of the fold lines 41 to 43 during a cutting operation. Note that, as shown in FIG. 5, an “end code” is added to the end of the coordinate data of the third fold line 43.

The control circuit 25 of the cutting device 11 controls the cutting section to cut the sheet material 200 along the partial patterns A, B, and C, the border 300, and the first, second, and third fold lines 41, 42, and 43 in that order on the basis of cutting data for folding.

Specifically, the X-axis movement mechanism and the Y-axis movement mechanism first relatively move the cutter cartridge 14 or the cutter to XY coordinates of the cutting start point P₀. The Z-axis movement mechanism causes the blade edge of the cutter to penetrate through the cutting start point P₀ of the partial pattern A at the sheet material 200. In this state, the X-axis movement mechanism and the Y-axis movement mechanism relatively move the blade edge to each set of coordinates such that the blade edge passes sequentially through the points P₀, P₁, . . . to cut the sheet material 200 along the line segments A₁, A₂, . . . . The cutter is relatively moved to the cutting end point P₁₀, thereby performing cutting along the partial pattern A, i.e., an outline of a “star.” Similarly, the cutter is relatively moved on the basis of cutting line data for the outlines of the partial patterns B and C, the border 300, and the fold lines 41 to 43 to perform sequential cutting.

Upon completion of cutting along the third fold line 43, the control circuit 25 moves the blade edge of the cutter away from the sheet material 200 on the basis of the above-described end code and moves the cutter to the origin O, which corresponds to a standby position of the carriage 15. With the above-described cutting operation, it is possible to cut along respective cutting lines for the outlines of the partial patterns A to C, the border 300, and the fold lines 41 to 43 and cut out the sheet piece 20 from the sheet material 200.

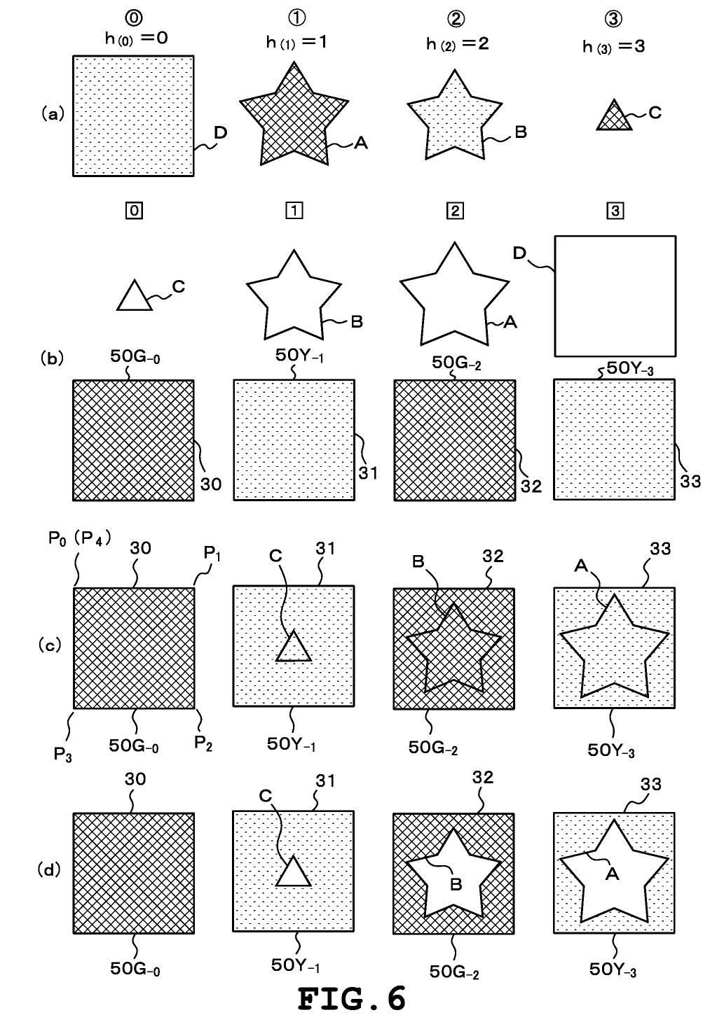

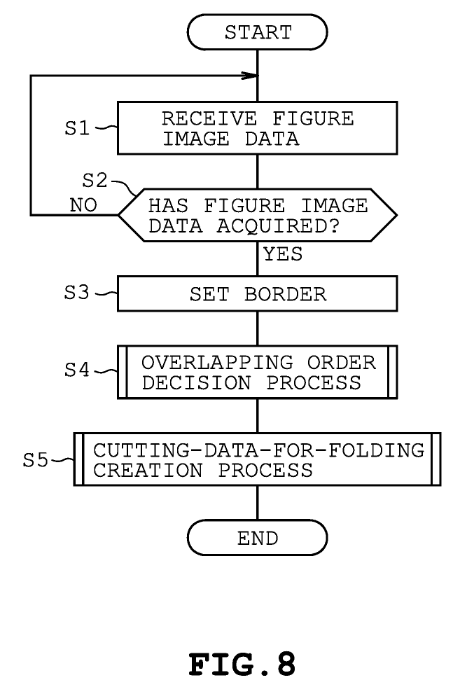

The operation of the above-described configuration will be described with reference to FIGS. 6 to 13. The flowcharts in FIGS. 8 to 13 each show a flow of the cutting data creation program to be executed by the control circuit 5 of the cutting data creation device 1.

In the cutting data creation device 1, the control circuit 5 executes a process shown in FIG. 8 upon activation of the cutting data creation program. The control circuit 5 first receives figure image data serving as a basis of cutting data for folding (step S1). More specifically, the control circuit 5 acquires the figure image data by, for example, causing the image scanner 10 to read an original drawing depicting a figure composed of “stars” and a “triangle” in accordance with a user's input operation (YES in step S2). The figure depicted in the original drawing is a figure for fabricating the decoration 51 in FIG. 3A and is a figure composed of four parts called a “peripheral area,” a “trimming part,” a “star,” and a “triangle,” as will be described later (see portion (a) of FIG. 6). In the figure, the “peripheral area” is yellow, the “trimming part” is green, the “star” is yellow, and the “triangle” is green. More specifically, a region outside the first partial pattern A (a “star”) is yellow, a region inside the first partial pattern A and outside the second partial pattern B (a smaller “star”) is green, a region inside the second partial pattern B and outside the third partial pattern C (a “triangle”) is yellow, and a region inside the third partial pattern C is green.

The control circuit 5 performs a process for setting the borders 30 to 33 for the “peripheral area” that is a frame pattern of the decoration 51 (step S3). Assume here that the borders 30 to 33 in the present exemplary embodiment are all set to have the same shape and that setting to specify a concrete shape is performed on the basis of the figure image data in the next step, S4.

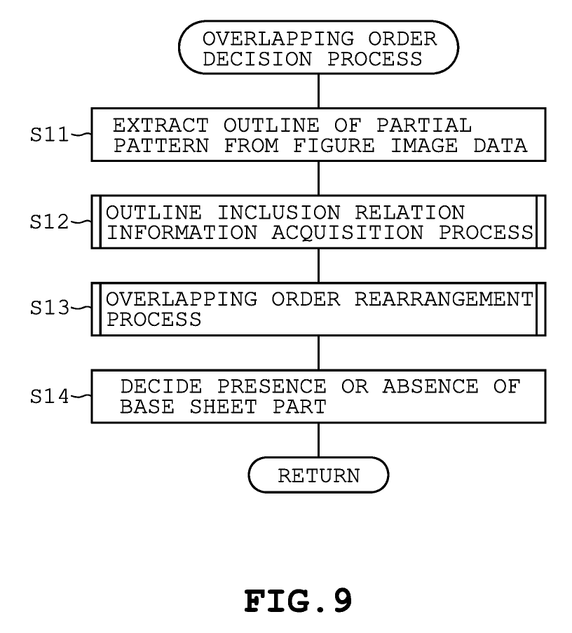

FIG. 9 shows an overlapping order decision process in step S4. In the overlapping order decision process, the control circuit 5 processes the figure image data by a known image processing technique to extract an outline for each color (step S11). At this time, for example, as indicated in order from the left side in portion (a) of FIG. 6, outlines of the “peripheral area”, the “trimming part”, the “star”, and the “triangle” are sequentially extracted. Each of the encircled numbers “0” to “3” in portion (a) of FIG. 6 represents a position in extraction order, and the total number n of extracted outlines is 4. Each outline is extracted as vector data including coordinate data and is assigned one of the pattern numbers “0” to “3” corresponding to the position in the extraction order.

In this case, the control circuit 5 identifies respective sets of pixels in the “peripheral area” and the “star” as yellow single-color regions and respective sets of pixels in the “trimming part” and the “triangle” as green single-color regions, on the basis of the figure image data. The control circuit 5 stores the colors of the respective identified single-color regions as the colors of layers 50G to 50Y (to be described later) (see portion (b) of FIG. 6) in the RAM 7. The control circuit 5 identifies the “peripheral area” with a pattern number of 0 in portion (a) of FIG. 6 as a part in which a yellow single-color region is demarcated (surrounded) by an outline for cutting out the frame pattern, i.e., the partial pattern D. The control circuit 5 identifies the “trimming part” with a pattern number of 1 as the partial pattern A having an outline demarcating a green single-color region and identifies the “star” with a pattern number of 2 as the partial pattern B having an outline demarcating a yellow single-color region. The control circuit 5 identifies the “triangle” with a pattern number of 3 as the partial pattern C having an outline demarcating a green single-color region.

Thus, the control circuit 5 can associate the outlines with the layers 50G to 50Y representing the respective single-color regions. The control circuit 5 also performs a process of setting the borders 30 to 33 of the respective layers 50G to 50Y. In the present exemplary embodiment, the outline of the outermost “peripheral area” is set as the square borders 30 to 33 (see portion (b) of FIG. 6). The control circuit 5 shifts to an inclusion information acquisition process of acquiring information on the inclusion relation among the partial patterns A to D (step S12).

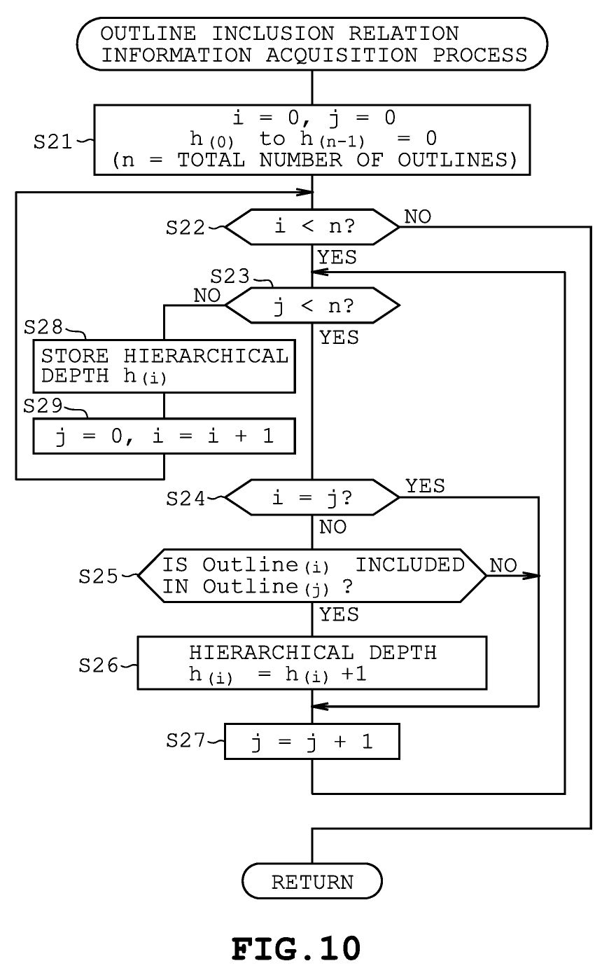

As shown in FIG. 10, in the inclusion information acquisition process, initial setting is first performed (step S21). In this step, to judge the inclusion relation between one partial pattern and a different partial pattern of the plurality of partial patterns A to D, the control circuit 5 resets and initializes one counter i corresponding to each pattern number and a different counter (a target counter j) to 0 (i=j=0). The control circuit 5 resets h₍ᵢ₎, which represents the depth in a hierarchy of each partial pattern, to 0. The hierarchical depth h₍ᵢ₎ represents the number of partial patterns, in which the partial pattern in question is included, as a hierarchical depth. When the partial pattern D for the “peripheral area” is at the top in the hierarchy (a depth of 0), the hierarchical depths of the partial patterns A to D are represented by h₍₀₎ to h₍ₙ₋₁₎, respectively.

The control circuit 5 judges the inclusion relation between the partial patterns on condition that values of the counter i and the target counter j are smaller than the total number n of outlines (YES in steps S22 and S23) and that the values of the counters i and j do not match (NO in step S24). At this point in time, the values of the counters i and j are both 0 (YES in step S24), and the inclusion relation between the partial patterns D and D with the pattern number of 0 is not judged. For this reason, the control circuit 5 increments the target counter j by 1 and sets the counter j to 1 (j=1) in step S27 to change a judgment object for the partial pattern D, and returns to step S23.

In this case, since the value of the target counter j is smaller than the total number n of outlines and does not match the value of the counter i, the conditions in steps S23 and S24 are satisfied. At this time, the control circuit 5 judges whether the outline of the partial pattern D with the pattern number i of 0 as one Outline₍ᵢ₎ is included in the outline of the partial pattern A with the pattern number j of 1 as different Outline₍ⱼ₎ (step S25). Outline₍ᵢ₎ or Outline₍ⱼ₎ is information representing a set of vector data of the outline of the partial pattern with the pattern number i or j. At this time, the control circuit 5 judges, on the basis of the coordinate data for the outlines, that Outline₍₀₎ of the partial pattern D is not included in Outline₍₁₎ of the partial pattern A (NO in step S25; see FIG. 3A).

After that, the control circuit 5 increments the target counter j by 1 and sets the target counter j to 2 (j=2) in step S27 and returns to step S23. In a case as well where the value of the target counter j is 2, the control circuit 5 determines that the conditions in steps S23 and S24 are satisfied and judges that Outline₍₀₎ of the partial pattern D with the pattern number i of 0 is not included in Outline₍₂₎ of the partial pattern B with the pattern number j of 2 (NO in step S25; see FIG. 3A).

As described above, since Outline₍₀₎ of the partial pattern D has a shape surrounding the different partial pattern A, B, or C, Outline₍₀₎ is not judged to be included in Outline₍ⱼ₎ of the different partial pattern A, B, or C. For this reason, even if the control circuit 5 repeatedly executes steps S23 to S25 and S27 for Outline₍₀₎ of the partial pattern D and judges the inclusion relation with Outline₍₃₎ of the partial pattern C with the pattern number j of 3, step S26 is not executed. A hierarchical depth h₍₀₎ of the partial pattern D remains at 0. Thus, if the control circuit 5 determines that the value of the target counter j has reached 4 that is the total number n of outlines (NO in step S23), the control circuit 5 sets the hierarchical depth h₍₀₎ of the partial pattern D to 0 and stores the hierarchical depth h₍₀₎ in the RAM 7 (step S28).

The control circuit 5 resets the target counter j to 0 and increments the counter i by 1 (step S29), and executes steps S22 to S27 for the partial pattern A with the pattern number i of 1.

In this case, the counter i indicates 1, and the target counter j indicates 0 (YES in steps S22 and S23 and NO in step S24). The control circuit 5 judges the inclusion relation between Outline₍₁₎ of the partial pattern A and Outline₍₀₎ of the partial pattern D (step S25). When the control circuit 5 determines that Outline₍₁₎ of the partial pattern A is included in Outline₍₀₎ of the partial pattern D (YES in step S25), the control circuit 5 increments a hierarchical depth h₍₁₎ of the partial pattern A by 1 and sets the hierarchical depth h₍₁₎ to 1 (step S26).

After that, the control circuit 5 executes the process for the partial pattern A with the pattern number i of 1 while incrementing the target counter j by 1 (step S27) and sequentially changing the object of inclusion relation judgment. If the target counter j indicates 1, i=j holds (YES in step S24). If the target counter j indicates 2 or 3, Outline₍₁₎ of the partial pattern A is not included in Outline₍₂₎ or Outline₍₃₎ of the different partial pattern B or C (NO in step S25; see FIG. 3A). For this reason, the control circuit 5 repeatedly executes steps S23 to S25 and S27 for Outline₍₁₎ of the partial pattern A and judges the inclusion relation with Outline₍₃₎ of the partial pattern C with the pattern number j of 3. When the value of the target counter j reaches 4 (NO in step S23), the control circuit 5 stores the hierarchical depth (h₍₁₎=1) of the partial pattern A in the RAM 7 (step S28).

The control circuit 5 resets the target counter j to 0 and increments the counter i by 1 (step S29), and executes steps S22 to S27 described above for the partial pattern B with the pattern number i of 2.

In this case, since the counter i indicates 2, and the target counter j indicates 0 (YES in steps S22 and S23 and NO in step S24), the control circuit 5 judges the inclusion relation between Outline₍₂₎ of the partial pattern B and Outline₍₀₎ of the partial pattern D (step S25). If the control circuit 5 determines that Outline₍₂₎ of the partial pattern B is included in Outline₍₀₎ of the partial pattern D (YES in step S25), the control circuit 5 increments a hierarchical depth h₍₂₎ of the partial pattern B by 1 and sets the hierarchical depth h₍₂₎ to 1 (step S26).

The control circuit 5 increments the value of the target counter j by 1 and sets the value to 1 (step S27) and judges the inclusion relation between Outline₍₂₎ of the partial pattern B and Outline₍₁₎ of the partial pattern A (steps S23 to S25). When the control circuit 5 determines that Outline₍₂₎ of the partial pattern B is included in Outline₍₁₎ of the partial pattern A (YES in step S25), the control circuit 5 increments the hierarchical depth h₍₂₎ of the partial pattern B by 1 and sets the hierarchical depth h₍₂₎ to 2 (step S26).

After that, the control circuit 5 executes the process for the partial pattern B with the pattern number i of 2 while incrementing the target counter j by 1 (step S27) and sequentially changing the object of inclusion relation target. If the target counter j indicates 2, i=j holds (YES in step S24). If the target counter j indicates 3, Outline₍₂₎ of the partial pattern B is not included in Outline₍₃₎ of the different partial pattern C (NO in step S25). For this reason, the control circuit 5 repeatedly executes steps S23 to S25 and S27 for Outline₍₂₎ of the partial pattern B. When the value of the target counter j reaches 4 (NO in step S23), the control circuit 5 stores the hierarchical depth (h₍₂₎=2) of the partial pattern B in the RAM 7 (step S28).

The control circuit 5 resets the target counter j to 0 and increments the counter i by 1 (step S29), and executes a process (steps S22 to S27) of judging the inclusion relations with the different partial patterns and obtaining a hierarchical depth h₍₃₎ for the partial pattern C with the pattern number i of 3, like the above-described cases of the partial patterns D, A, and B. In this case, Outline₍₃₎ of the partial pattern C with the pattern number i of 3 is included in three Outline₍₀₎ to Outline₍₂₎ of the partial patterns D, A, and B. Thus, the hierarchical depth h₍₃₎ of the partial pattern C is 3 (step S26). In the above-described manner, the control circuit 5 stores all the partial patterns D and A to C in association with their hierarchical depths (step S28). When the value of the counter i reaches 4 (step S29 and NO in step S22), the process returns to step S13.

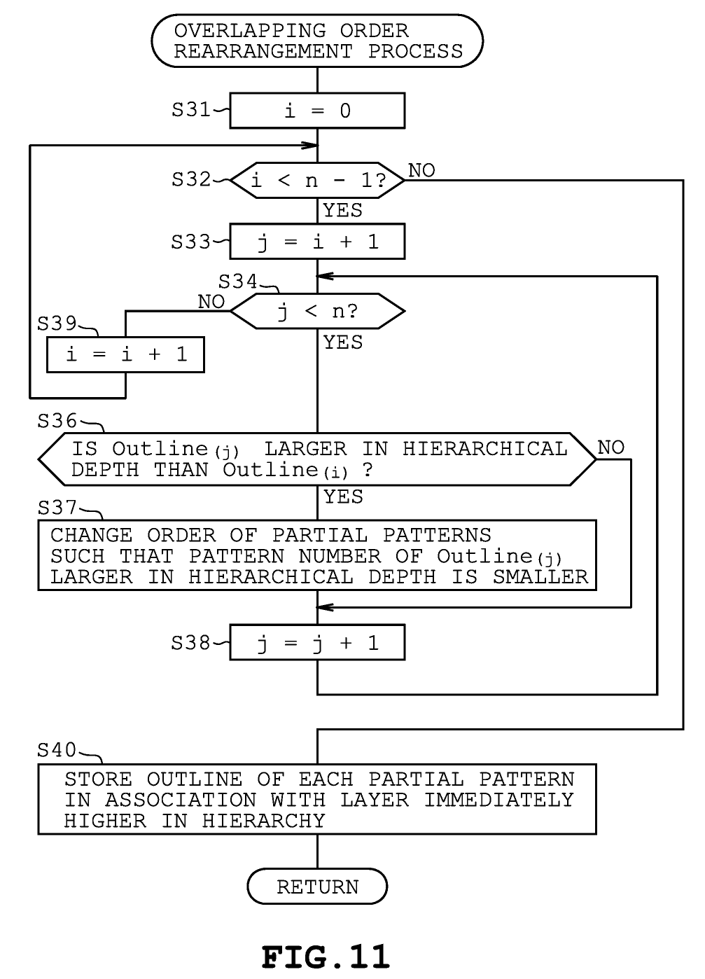

FIG. 11 shows an overlapping order rearrangement process in step S13. In the rearrangement process, the order of the partial patterns A to D extracted in step S11 described above is rearranged such that the entire pattern M has a concave shape. The rearrangement of the order of the partial patterns is performed by changing the association between the encircled pattern numbers in portion (a) of FIG. 6 and Outline₍₀₎ to Outline₍₃₎ on the basis of the hierarchical depths of the partial patterns.

More specifically, in step S31 of FIG. 11, the control circuit 5 resets the counter i for one partial pattern to 0. In step S32, the control circuit 5 determines whether a value of the counter i is smaller than (the total number n of outlines−1). Since the value of the counter i is 0 smaller than (the total number n of outlines−1) at first, the control circuit 5 shifts to step S33. On the other hand, if the value of the counter i is equal to or larger than (the total number n of outlines−1), the control circuit 5 shifts to step S40.

In step S33, the control circuit 5 increments the counter i by 1 to set the target counter j for a different partial pattern (j=i+1) to 1. In step S34, the control circuit 5 determines whether the value of the target counter j is smaller than the total number n of outlines. If the value of the target counter j is smaller than the total number n of outlines, the control circuit 5 shifts to step S36. On the other hand, if the value of the target counter is equal to or larger than the total number n of outlines, the control circuit 5 shifts to step S39.

In step S36, the control circuit 5 judges whether the partial pattern A (Outline₍₁₎) with the pattern number of 1 corresponding to the value of the target counter j is larger in hierarchical depth than the partial pattern D (Outline₍₀₎) with the pattern number of 0 corresponding to the value of the counter i. In this case, the control circuit 5 judges that the hierarchical depth (see h₍₁₎ in portion (a) of FIG. 6) of the partial pattern A is 1 larger than the hierarchical depth (h₍₀₎=0) of the partial pattern D (YES in step S36). For this reason, the control circuit 5 rearranges the order such that the pattern number of the partial pattern A is smaller than that of the partial pattern D (the partial pattern A is recessed toward the partial pattern D) (step S37). The ordinal positions of the partial patterns D and A are changed such that the pattern numbers of the partial pattern A larger in hierarchical depth and the partial pattern D are “0” and “1,” respectively. Note that, if NO in step S36, the control circuit 5 shifts to step S38 without changing the ordinal positions of the partial patterns.

The control circuit 5 increments the value of the target counter j by 1 and sets the value to 2 in step S38. After that, the control circuit 5 returns to step S34 to repeat the same processing. Specifically, the control circuit 5 sets the partial pattern B with the pattern number of 2 as a judgment object and judges the hierarchical depth relation with the partial pattern A with the pattern number of 0 corresponding to the value of the counter i (step S36). In this case, since the partial pattern B is larger in hierarchical depth than the partial pattern A (YES in step S36), the control circuit 5 changes the ordinal positions of the partial patterns A and B such that the pattern numbers of the partial patterns B and A are “0” and “2,” respectively.

After the control circuit 5 increments the value of the target counter j by 1 and sets the value to 3 in step S38, the control circuit 5 returns to step S34 to repeat the same processing. Specifically, the control circuit 5 sets the partial pattern C with the pattern number of 3 as the judgment object and judges the hierarchical depth relation with the partial pattern B with the pattern number of 0 (step S36). In this case, since the partial pattern C is larger in hierarchical depth than the partial pattern B (YES in step S36), the control circuit 5 changes the ordinal positions of the partial patterns B and C such that the pattern numbers of the partial patterns C and B are “0” and “3,” respectively.

In the above-described manner, the value of the target counter j is incremented by 1 while the value of the counter i remains at 0 (step S38). When the value of the target counter j reaches “4” that is the value of the total number n of outlines (NO in step S34), the partial patterns line up in the order of the partial pattern C with the pattern number of 0, the partial pattern D with the pattern number of 1, the partial pattern A with the pattern number of 2, the partial pattern B with the pattern number of 3.

The control circuit 5 increments the value of the counter i by 1 and sets the value to 1 (step S39), and sets the value of the target counter j to the sum of the value of the counter i and 1, i.e., 2 (step S33). The control circuit 5 sequentially judges the hierarchical depth relations between the partial pattern D with the pattern number of 1 corresponding to the value of the counter i and the partial patterns A and B with the pattern numbers of 2 and a subsequent number corresponding to values of the target counter j and rearranges the order of the partial patterns D, A, and B (steps S34 to S38). When the value of the target counter j reaches 4 (NO in step S34), the partial patterns line up in the order of the partial pattern C with the pattern number of 0, the partial pattern B with the pattern number of 1, the partial pattern D with the pattern number of 2, the partial pattern A with the pattern number of 3.

Further, the control circuit 5 increments the value of the counter i and that of the target counter j in the above-described manner (i=2 in step S39 and j=3 in step S33) and executes steps S34 to S38 for the partial patterns D and A with the pattern numbers of 2 and 3, thereby rearranging the order on the basis of the hierarchical depths of the partial patterns D and A. As a result, when the value of the target counter j reaches 4 (step S38), and the value of the counter i reaches n−1 (i.e., 3) (step S39 and NO in step S32), the partial patterns line up in the order of the partial pattern C with the pattern number of 0, the partial pattern B with the pattern number of 1, the partial pattern A with the pattern number of 2, the partial pattern D with the pattern number of 3 (see the upper side in portion (b) of FIG. 6). As described above, the control circuit 5 changes the ordinal positions of the partial patterns C, B, A, and D representing the entire pattern M with a concave shape such that smaller pattern numbers are assigned in order from the bottom in the hierarchy, as indicated by the boxed numbers “0” to “3” in portion (b) of FIG. 6.

In step S40, the control circuit 5 performs a process of setting, for each of the layers 50G to 50Y, an outline of a partial pattern on the basis of the changed ordinal position. The layer setting process will be described with reference to FIGS. 6B to 6D. The layers 50G, 50Y, 50G, and 50Y shown on the lower side in portion (b) of FIG. 6 are linked to the partial patterns C, B, A, and D on the upper side as layers representing single-color regions for the partial patterns C, B, A, and D, as described earlier. Thus, the ordinal positions of the layers 50G to 50Y correspond to the pattern numbers, i.e., the ordinal positions of sheet parts to be laid on and in front of a base sheet part when the sheet piece 20 is folded in layers. The control circuit 5 assigns an ordinal position of “0” to a base layer 50 corresponding to a base sheet part; an ordinal position of “1,” the first layer 50 corresponding to a first sheet part; an ordinal position of “2,” the second layer 50 corresponding to a second sheet part; and an ordinal position of “3,” the third layer 50 corresponding to a third sheet part. In the following description, the layers are referred to as a base layer 50G₋₀, a first layer 50Y₋₁, a second layer 50G₋₂, and a third layer 50Y₋₃, in order from the left in portion (b) of FIG. 6.

As shown in FIGS. 3C and 6D, to represent the entire pattern M with a concave shape, the insides of the partial patterns A to C are represented by the rear sheet parts 20₋₀ to 20₋₂ (the base layer 50G₋₀ to the second layer 50G₋₂) in terms of the foremost sheet part 20₋₃ (the third layer 50Y₋₃). For this reason, the control circuit 5 sets the outlines of the partial patterns A to C on the respective layers 50Y₋₁ to 50Y₋₃ immediately higher in the hierarchy in the layer setting process. With this setting, the association between the layers and the outlines of the partial patterns is changed such that the layer 50Y₋₁ with the ordinal position of “1” and the partial pattern C are associated, the second layer 50G₋₂ with the ordinal position of “2” and the partial pattern B are associated, and the third layer 50Y₋₃ with the ordinal position of “3” and the partial pattern A are associated, as shown in portion (c) of FIG. 6. The outline of the partial pattern D is associated with the base layer 50G₋₀ with the ordinal position of “0” as the border 30, and the other layers 50Y₋₁ to 50Y₋₃ are associated with the respective borders 31 to 33 having a common shape (see steps S3 and S11 described above). The control circuit 5 stores a set of vector data of a border and an outline of a partial pattern associated with each of the layers 50G₋₀ to 50Y₋₃ as “LayeredLine” in the RAM 7.

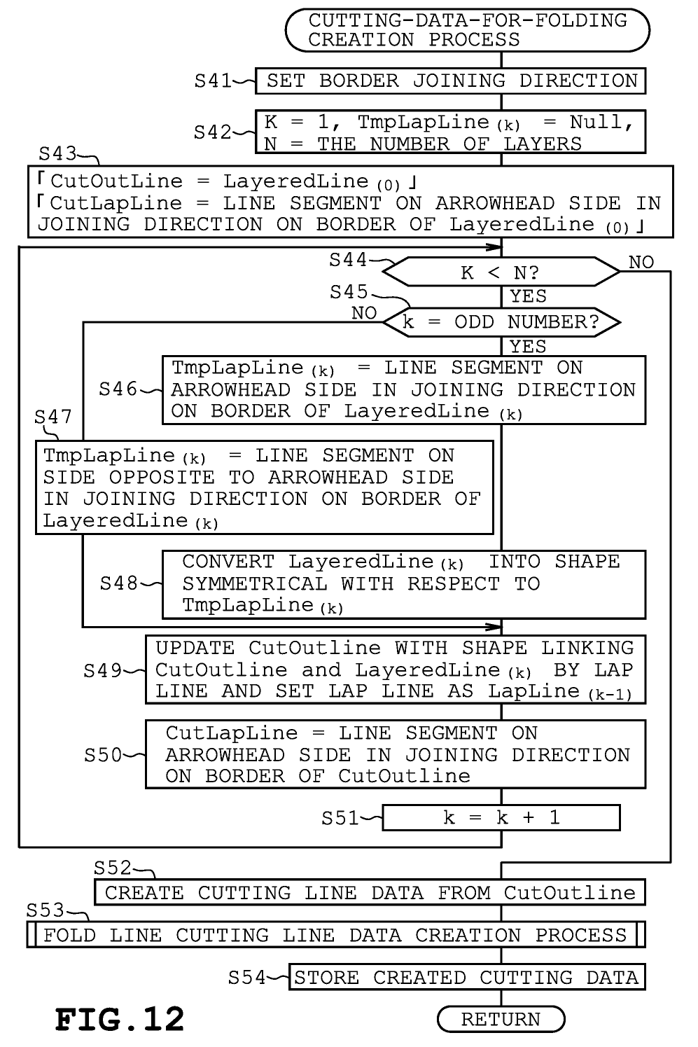

After that, the control circuit 5 returns to step S14 in FIG. 9 and displays a sheet part setting screen (not shown) for selecting one of “With base sheet part” and “Without base sheet part” on the display 3. A user makes such a selection by operating the input unit 4, such as the mouse 4b, while viewing the sheet part setting screen. When the control circuit 5 decides the presence or absence of a base sheet part in accordance with a selection instruction from the input unit 4, the control circuit 5 returns to step S5 to shift to a cutting-data-for-folding creation process (see FIG. 12). Note that the following description is given on the assumption that “With base sheet part” is selected.

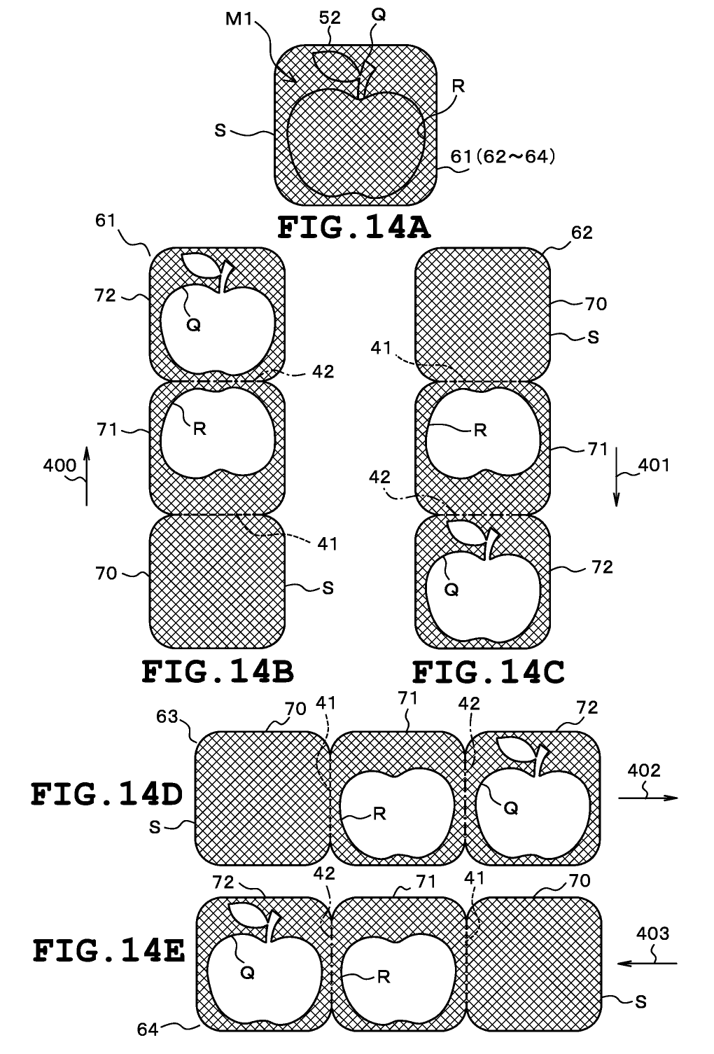

In the cutting-data-for-folding creation process, the control circuit 5 first sets a joining direction in which the borders 30 to 33 are linked among the layers 50G₋₀ to 50Y₋₃ (step S41). As will be described in detail later, the joining direction for the layers 50G₋₀ to 50Y₋₃ is one of four directions (see arrows 400 to 403 in FIG. 14) appropriate for the shapes of the borders 30 to 33. In the present exemplary embodiment, in the XY coordinate system where a rightward direction with respect to the sheet surface in FIG. 7 is an X-axis positive direction and a downward direction is a Y-axis positive direction, a Y-axis negative direction is designated as the joining direction by default (see the arrow 400 in portion (a) and (c) of FIG. 7). The default direction is obtained by the control circuit 5 in accordance with the shapes (coordinate data) of the borders 30 to 33, and a linking direction is specified by sequentially arranging the other layers 50Y₋₁ to 50Y₋₃ in the Y-axis negative direction 400 with respect to the base layer 50G₋₀.

In step S42, the control circuit 5 sets a counter k corresponding to the ordinal positions of the layers 50G₋₀ to 50Y₋₃ to 1 and performs initial setting for joining starting with the first layer 50Y₋₁ with the ordinal position of “1” for the base layer 50G₋₀. In this case, the control circuit 5 sets TmpLapLine₍ₖ₎ that specifies the above-described fold line position to null. TmpLapLine₍ₖ₎ is information representing a set of vector data of a line indicating a fold line position on a corresponding one of the borders 30 to 33 of LayeredLine₍ₖ₎ set for each layer.

The control circuit 5 sets, in initial setting, CutOutline to LayeredLine₍₀₎, i.e., vector data of the border 30 of the base layer 50G₋₀ (step S43). CutOutline is information representing a set of vector data of a border and an outline for creating cutting line data. The control circuit 5 also sets CutLapLine on the border 30 of LayeredLine₍₀₎. CutLapLine is information representing a set of vector data of a line indicating a fold line position for creating cutting line data. More specifically, CutLapLine is set to a line segment 30a on an arrowhead side in the Y-axis negative direction 400 on the border 30 in accordance with the joining direction designated in step S41 described above (see a thick line on the left side in portion (a) of FIG. 7).

In step S44, the control circuit 5 determines whether the counter k is smaller than the number N of layers. Since a value of the counter k is 1 smaller than the number N of layers at first, the control circuit 5 shifts to step S45. In contrast, if the value of the counter k is 4 equal to the number N of layers or larger than the number N of layers, the control circuit 5 shifts to step S52. In step S45, the control circuit 5 determines whether the value of the counter k is an odd number. If the value of the counter k is an odd number (YES), the control circuit 5 shifts to step S46. On the other hand, if the value of the counter k is an even number (NO), the control circuit 5 shifts to step S47. Since the value of k is 1 at this time (YES in step S45), the control circuit 5 shifts to step S46.

In step S46, the control circuit 5 sets TmpLapLine₍₁₎ on the border 31 of LayeredLine₍₁₎ for the first layer 50Y₋₁ corresponding to the current value (=1) of the counter k. In this case, TmpLapLine₍₁₎ is set to a line segment 31a on the arrowhead side in the Y-axis negative direction 400 on the border 31 on the basis of the joining direction designated in step S41 described above, as indicated by a thick line in portion (a) of FIG. 7. The line segment 31a set as TmpLapLine₍₁₎ or the line segment 30a set as CutLapLine described above is a lap line for laying a part of the border 31 of the one layer 50Y₋₁ (the partial pattern C) of interest on a part of the border 30 of the different base layer 50G₋₀ (the partial pattern D). These line segments 30a and 31a are each a line orthogonal to a fold direction (or the Y-axis negative direction 400) for folding along the own line segment but may be each composed of a line segment generally orthogonal to the fold direction.

The control circuit 5 converts, for the first layer 50Y₋₁, LayeredLine₍₁₎ such that the partial pattern C and the border 31 have shapes symmetrical with respect to the line segment 31a of TmpLapLine₍₁₎ (step S48). With this conversion, LayeredLine₍₁₎ is converted into data in which the partial pattern C and the border 31 have shapes symmetrical with respect to the line segment 31a as an axis of symmetry (see FIG. 4C and portion (a) of FIG. 7).

The control circuit 5 then merges LayeredLine₍₀₎ of the base layer 50G₋₀ set as CutOutline and LayeredLine₍₁₎ of the first layer 50Y₋₁ (step S49). In this merging, the control circuit 5 joins the border 30 of LayeredLine₍₀₎ and the border 31 of LayeredLine₍₁₎ in a rectangle shape having the borders 30 and 31 linked by lapping the borders 30 and 31 on top of each other at the line segments 30a and 31a as CutLapLine and TmpLapLine₍₁₎ (see portion (a) of FIG. 7). With this joining, the control circuit 5 sets (updates) CutOutline to vector data of a border 298 which is obtained by linking the two borders 30 and 31 and is composed of line segments 31c, 31d 30b, 30c, 30d and 31b and the outline of the partial pattern C. The control circuit 5 also updates the two lapped line segments 30a and 31a as one LapLine₍₀₎.

Note that the control circuit 5 changes the yellow single-color region of the first layer 50Y₋₁ to a first layer 50G₋₁ representing a green single-color region along with execution of steps S48 and S49 described above (see portion (a) of FIG. 7). Specifically, if the value of the counter k is an odd number (YES in step S45 described above), the corresponding sheet part 20₋₁ is reversed upon folding, and the corresponding layer is changed from the yellow layer to the green layer 50G₋₁ so as to correspond to the color of the reverse face of the sheet piece 20.

The control circuit 5 then sets CutLapLine to the line segment 31c on the arrowhead side in the Y-axis negative direction 400 on the border 298 of CutOutline (step S50). The control circuit 5 increments the value of the counter k by 1 in step S51, thereby executing steps S44 to S50 for the second layer 50G₋₂ with the ordinal position of “2.”

In this case, the value of the counter k is 2 (YES in step S44), and the control circuit 5 determines that the value is not an odd number (NO in step S45). The control circuit 5 also sets TmpLapLine₍₂₎ on the border 32 of LayeredLine₍₂₎ for the second layer 50G₋₂. At this time, as indicated by a thick line in portion (b) of FIG. 7, TmpLapLine₍₂₎ is set to a line segment 32c on a side opposite to the arrowhead side in the joining direction (on an arrowhead side in the Y-axis positive direction 401) on the border 32, on the basis of the joining direction.

The control circuit 5 then merges CutOutline and LayeredLine₍₂₎ of the second layer 50G₋₂ (step S49). In this merging, the control circuit 5 joins the border 298 of CutOutline and the border 32 of the second layer 50G₋₂ by lapping the borders 298 and 32 on top of each other at the line segments 31c and 32c as CutLapLine and TmpLapLine₍₂₎ (see portion (b) of FIG. 7). With this joining, the control circuit 5 updates CutOutline with vector data of a border 299 which is obtained by linking the borders 30 to 32 and is composed of line segments 32a, 32b, 31d, 30b, 30c, 30d, 31b and 32d and the outlines of the partial patterns C and B. The control circuit 5 also updates the two lapped line segments 31c and 32c as one LapLine₍₁₎.

Further, the control circuit 5 sets CutLapLine to the line segment 32a on the arrowhead side in the Y-axis negative direction 400 on the border 299 of CutOutline (step S50). The control circuit 5 increments the value of the counter k by 1 in step S51, thereby executing steps S44 to S50 for the third layer 50Y₋₃ with the ordinal position of “3.”

In this case, the value of the counter k is 3 (YES in step S44), and the control circuit 5 determines that the value is an odd number (YES in step S45). The control circuit 5 also sets TmpLapLine₍₃₎ on the border 33 of LayeredLine₍₃₎ for the third layer 50Y₋₃ (step S46). At this time, as indicated by a thick line in portion (c) of FIG. 7, TmpLapLine₍₃₎ is set on a line segment 33a on the arrowhead side in the Y-axis negative direction 400 on the border 33 on the basis of the joining direction.

The control circuit 5 converts, for the third layer 50Y₋₃, LayeredLine₍₃₎ such that the partial pattern A and the border 33 have shapes symmetrical with respect to the line segment 33a of TmpLapLine₍₃₎ (step S48). With this conversion, LayeredLine₍₃₎ is converted into data in which the partial pattern A and the border 33 have shapes symmetrical with respect to the line segment 33a as an axis of symmetry (see FIG. 4A and portion (c) of FIG. 7).

The control circuit 5 then merges CutOutline and LayeredLine₍₀₎ of the third layer 50Y₋₃ (step S49). In this merging, the control circuit 5 joins the border 299 of CutOutline and the border 33 of LayeredLine₍₃₎ by lapping the borders 299 and 33 on top of each other at the line segments 32a and 33a as CutLapLine and TmpLapLine₍₃₎ (see portion (c) of FIG. 7). With this joining, the control circuit 5 sets CutOutline to vector data of the border 300 that is obtained by linking the borders 30 to 33 and is composed of line segments 33c, 33d, 32b, 31d, 30b, 30c, 30d, 31b, 32d and 33b and the outlines of the partial patterns A to C. The control circuit 5 also updates the two lapped line segments 32a and 33a as one LapLine₍₂₎. Note that, as in the case of the first layer 50G₋₁, the control circuit 5 changes the third layer 50Y₋₃ with a yellow single-color region to a third layer 50G-3 with a green single-color region (see portion (c) of FIG. 7).

After that, the control circuit 5 sets CutLapLine to the line segment 33c on the arrowhead side in the Y-axis negative direction 400 on the border 300 of CutOutline (step S50). The control circuit 5 also increments the value of the counter k by 1 (step S51) and determines in step S44 that the value of “4” of the counter k has reached the number N of layers (NO).

For this reason, the control circuit 5 creates cutting line data for the border 300, not including LapLine₍₀₎ to LapLine₍₂₎, and the partial patterns A to C set as CutOutline (step S52). At this time, the control circuit 5 creates cutting line data having a point P₀ as a cutting start point and a cutting end point on the basis of coordinate data of the point P₀ and points P₁ to P₄ of the border 300 for the whole (see FIG. 5 and portion (c) of FIG. 7). On the basis of coordinate data of the points P₀ to P₁₀ of the partial pattern A, the points P₀ to P₁₀ of the partial pattern B, and the points P₀ to P₃ of the partial pattern C, cutting line data for three outlines having the respective points P₀ as cutting start points and cutting end points is created (see FIGS. 5 and 4A to 4C).

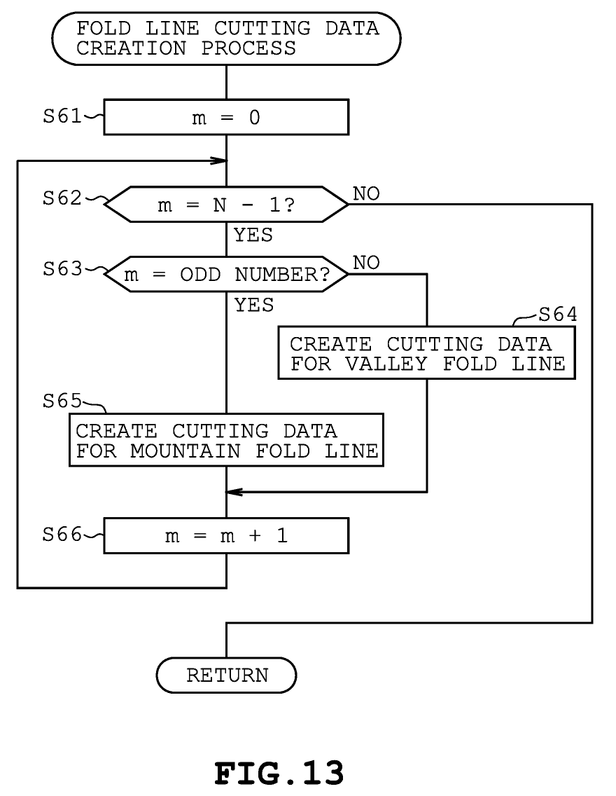

Further, the control circuit 5 executes a fold line cutting line data creation process for LapLine₍₀₎ to LapLine₍₂₎ in step S53 (see FIG. 13). In this case, the control circuit 5 resets a counter m corresponding to the ordinal position of linking by LapLine to 0 (step S61) and determines whether a value of the counter m is smaller than “the number N of layers−1” (step S62). Since the value of the counter m is smaller than “the number N of layers−1” at first, the control circuit 5 shifts to step S63. On the other hand, if the value of the counter m is equal to or larger than “the number N of layers−1”, the control circuit 5 returns to step S54.

In step S63, the control circuit 5 determines whether the value of the counter m is an odd number. If the value of the counter m is an odd number (YES), the control circuit 5 shifts to step S65. On the other hand, if the value of the counter m is an even number (NO), the control circuit 5 shifts to step S64.

In step S64, the control circuit 5 creates cutting line data for the valley fold line 41, for LapLine₍₀₎ corresponding to the current value (=0) of the counter m. At this time, on the basis of coordinate data of points Ps and Pe at two ends of LapLine₍₀₎ (see portion (c) of FIG. 7 and FIG. 5), the control circuit 5 creates cutting line data including an attribute flag specifying a dashed line of the valley fold line 41, using the point Ps as a cutting start point and the point Pe as a cutting end point.

The control circuit 5 increments the value of the counter m by 1 and sets the value to 1 (m=1) in step S66, and returns to step S62. The control circuit 5 determines that the value of “1” of the counter m is smaller than “the number N of layers−1” and is an odd number (YES in steps S62 and S63). In this case, the control circuit 5 creates cutting line data for the mountain fold line 42, for LapLine₍₁₎ corresponding to the value of the counter m (step S65). At this time, on the basis of coordinate data of points Ps and Pe at two ends of LapLine₍₁₎ (see portion (c) of FIG. 7 and FIG. 5), the control circuit 5 creates cutting line data including an attribute flag specifying an alternate long and short dash line of the mountain fold line 42, using the point Ps as a cutting start point and the point Pe as a cutting end point.

The control circuit 5 increments the value of the counter m by 1 and sets the value to 2 in step S66 and determines that the value of “2” of the counter m is smaller than “the number N of layers−1” and is not an odd number (YES in step S62 and NO in step S63). In this case, the control circuit 5 creates cutting line data for the valley fold line 43, for LapLine₍₂₎ corresponding to the value of the counter m (step S64). At this time, on the basis of coordinate data of points Ps and Pe at two ends of LapLine₍₂₎ (see portion (c) of FIG. 7 and FIG. 5), the control circuit 5 creates cutting line data including an attribute flag specifying a dashed line of the valley fold line 43, using the points Ps and Pe as a cutting start point and a cutting end point, respectively.

After that, the control circuit 5 increments the value of the counter m by 1 (step S66), determines in step S62 that the value of “3” of the counter m has reached “the number N of layers−1” (NO), and returns to step S54. The control circuit 5 stores created cutting line data for the outlines of the partial patterns A to C, the border 300, and the fold lines 41 to 43 in the RAM 7 (step S54). The control circuit 5 also adds the end code as described earlier, data for display, and the like to the cutting line data and ends the cutting-data-for-folding creation process (the end).

Note that, as for the data for display, the entire pattern M can be represented with a concave shape using the layers 50G₋₀ to 50Y₋₃ stored in step S40. Specifically, as shown in portion (d) of FIG. 6, the yellow image layer 50Y₋₁ that is obtained by cutting out a part inside the outline of the partial pattern C from the first layer 50Y₋₁, the green image layer 50G₋₂ that is obtained by cutting out a part inside the outline of the partial pattern B from the second layer 50G₋₂, and the yellow image layer 50Y₋₃ that is obtained by cutting out a part inside the outline of the partial pattern A from the third layer 50Y₋₃ are generated. The yellow image layer 50Y₋₁ is laid on and in front of the front of the green image layer 50G₋₀ serving as the base layer 50G₋₀, the green image layer 50G₋₂ is laid on and in front of the image layer 50Y₋₁, and the yellow image layer 50Y₋₃ is laid on and in front of the image layer 50G₋₂ (see FIG. 3C). In terms of the foremost yellow image layer 50Y₋₃, the inside of the partial pattern A is represented in two colors, green and yellow, by the rear image layers 50G₋₀ to 50G₋₂, and the entire pattern M has a concave shape.

It is also possible to receive cutting data for folding created by the cutting data creation device 1 on the cutting device 11 side and cause the cutting device 11 to execute a cutting operation on the basis of the cutting data for folding. In this case, the cutting device 11 can cut the outlines of the partial patterns A to C and the border 300 of one sheet material 200 and cut out one sheet piece 20 with the fold lines 41 to 43 formed therein (see FIG. 3B).

A user makes a valley fold along the valley fold line 41, a mountain fold along the mountain fold line 42, and a valley fold along the valley fold line 43 on the sheet piece 20 using the fold lines 41 to 43 as marks as indicators of folding to fold the sheet piece 20 in a zigzag (like an accordion). For this reason, folding the sheet piece 20 such that the sheet piece 20 is partitioned into the sheet parts 20₋₀ to 20₋₃ demarcated by the borders 30 to 33 allows fabrication of the decoration 51 representing the entire pattern M formed of a combination of the plurality of partial patterns A to D and having “stars” and a “triangle”, with a concave shape. The decoration 51 is represented in two colors, green of the sheet parts 20₋₀ and 20₋₂ and yellow of the sheet parts 20₋₁ and 20₋₃ that are reversed upon folding (see FIG. 3A).

As described above, the ordinal position in the overlapping order from the base sheet part 20₋₀ of each of the partial patterns A and C of the sheet parts 20₋₁ and 20₋₃ that are reversed upon folding is even-numbered (odd-numbered in step S45 described above because the ordinal position is counted from “1”), as shown in FIG. 3C. In the present exemplary embodiment, the symmetrical conversion step in step S48 of converting the partial patterns A and C into partial patterns which have shapes symmetrical with respect to the lap lines 31a and 33a of the borders 31 and 33 is executed. For this reason, even if the sheet piece 20 is folded like an accordion, cutting data for folding which allows placement of the partial patterns A and C in desired orientations can be automatically created.

The idea of fabricating a decoration by stacking respective individual partial patterns (sheets) cut out from a plurality of sheet materials, unlike the present exemplary embodiment, is conceivable. The idea, however, needs a plurality of sheet materials, needs much fabrication effort, and needs position and orientation adjustment at the time of laying individual sheets on top of another. In contrast, the sheet parts 20₋₀ to 20₋₃ according to the present exemplary embodiment are linked as one sheet piece 20, and effort of fabrication and fabrication time for the decoration 51 can be significantly reduced. Accurate alignment between the partial patterns A to D can be achieved just by folding the sheet piece 20 using the fold lines 41 to 43 as indicators of folding such that the sheet piece 20 is partitioned into the sheet parts 20₋₀ to 20₋₃.

As has been described above, a cutting data creation method according to the present exemplary embodiment includes a lap line setting step (steps S43 to S47, S49, and S50) of setting a lap line (the line segments 30a, 31a, 31c, 32c, 32a, and 33a) for laying a part of a border of one partial pattern and a part of a border of a different partial pattern on top of each other, for each of the partial patterns, a joining step (step S49) of joining the border of the one partial pattern and the border of the different partial pattern in a shape having the borders linked at the lap lines set in the lap line setting step, and a cutting data creation step (step S52) of creating cutting data for cutting along the border 300 that is obtained by excluding the lap lines from the borders 30 to 33 linked in the joining step.

According to the above-described configuration, the lap lines for the part of the one partial pattern and the part of the different partial pattern are set in the lap line setting step, and the border of the one partial pattern and the border of the different partial pattern are joined in the shape having the borders linked at the lap lines in the joining step. This allows creation of cutting data for cutting along the border 300 that is obtained by excluding the lap lines from the borders 30 to 33 pertaining to the plurality of partial patterns A to D, for a sheet (the sheet piece 20) as an object to be cut. For this reason, by cutting out the sheet piece 20 on the basis of the created cutting data and folding the sheet piece 20 in layers such that the sheet piece 20 is partitioned into units demarcated by the borders 30 to 33, the decoration 51 representing the entire pattern M formed of a combination of the plurality of partial patterns A to D can be fabricated. This allows a reduction in the number of sheets needed to fabricate the decoration 51 and a reduction in fabrication effort.

The control circuit 5 of the cutting data creation device 1 is configured as a lap line setting section which sets the lap line described above for each partial pattern, a joining section which joins a border of one partial pattern and a border of a different partial pattern in a shape having the borders linked at the lap lines, and a cutting data creation section which creates cutting data for cutting along the border 300 that is obtained by excluding the lap lines from the borders 30 to 33 linked by the joining section.

According to the above-described configuration, lap lines for a part of the border of the one partial pattern and a part of the border of the different partial pattern are set by the lap line setting section, and the border of the one partial pattern and the border of the different partial pattern are joined in the shape having the borders linked at the lap lines by the joining section. This allows creation of cutting data for cutting along the border 300 that is obtained by excluding the lap lines from the borders 30 to 33 pertaining to the plurality of partial patterns A to D, for the sheet piece 20 as an object to be cut. For this reason, by cutting out the sheet piece 20 on the basis of the created cutting data and folding the sheet piece 20 in layers such that the sheet piece 20 is partitioned into units demarcated by the borders 30 to 33, the decoration 51 representing the entire pattern M formed of a combination of the plurality of partial patterns A to D can be fabricated. This allows a reduction in the number of sheets needed to fabricate the decoration 51 and a reduction in fabrication effort.

The cutting data creation method includes an ordinal position decision step (step S4 by the control circuit 5 as an ordinal position decision section) of deciding ordinal positions in the overlapping order of the plurality of partial patterns A to D when the sheet piece 20 is folded in layers, and the lap line setting step (the lap line setting section) sets lap lines for the borders 30 to 33 of the respective partial patterns A to D in accordance with the ordinal positions decided by the ordinal position decision section.

According to the above-described configuration, the lap lines for the borders 30 to 33 are set in accordance with the ordinal positions in the overlapping order of the partial patterns A to D when the sheet piece 20 is folded in layers. This allows joining of the borders 30 to 33 at the lap lines set in accordance with the ordinal positions for the sheet piece 20.

The cutting data creation method includes a symmetrical conversion step (step S48 by the control circuit 5 as a symmetrical conversion section) of converting, among the plurality of partial patterns A to D, the partial patterns A and C, ordinal positions of which in the overlapping order when the sheet piece 20 is folded in layers are even-numbered, into the partial patterns A and C that have shapes symmetrical with respect to the lap lines 31a and 33a of the borders 31 and 33. According to this configuration, by converting the partial patterns A and C to be reversed upon folding of the sheet piece 20 into symmetrical shapes, cutting data for folding, from which a combination with the other partial patterns B and D is obtained by the folding, can be created.

The borders 30 to 33 contain the partial patterns A to C or constitute at least a part of the outline of the partial pattern D. According to this configuration, the partial patterns A to D are demarcated by the borders 30 to 33. Overlaps among the partial patterns A to D can be achieved by folding the sheet piece 20 in layers such that the sheet piece 20 is partitioned into demarcation units.

The cutting data creation step (the cutting data creation section) further creates cutting data which is a mark as an indicator of folding using the lap line described above as a fold line position. According to this configuration, a mark in the sheet piece 20 serves as an indicator for setting a lap line as a folding position, and simplification of folding of the sheet piece 20 can be achieved.

The mark described above is a line indicating a fold line position and includes the mountain fold line 42 indicating a position where the sheet piece 20 is to be mountain-folded and the valley fold lines 41 and 43 indicating positions where the sheet piece 20 is to be valley-folded. The mountain fold line 42 is different in line type from the valley fold lines 41 and 43. According to this configuration, the sheet piece 20 can be easily mountain-folded and valley-folded using the mountain fold line 42 and the valley fold lines 41 and 43 as marks.

Note that the fold line position may be specified by a line other than the dashed line and the alternate long and short dash line described above and that the mark may be an indicator of folding.

The cutting data creation method includes a direction designation step (step S41 by the control circuit 5 as a direction designation section) of designating a direction in which the borders 30 to 33 are linked, and the lap line setting step sets a lap line in accordance with the direction designated in the direction designation step. According to this configuration, cutting data for folding, from which the border 300 obtained by joining the border of the one partial pattern and the border of the different partial pattern in accordance with the direction designated in the direction designation step is obtained, can be created.

### Other Exemplary Embodiments

FIGS. 14 to 16 show second to fourth exemplary embodiments of the present disclosure. The same components as those already described are denoted by the same reference numerals, and a description thereof will be omitted. Differences will be described below.

FIG. 14A shows a decoration 52 according to the second exemplary embodiment. An entire pattern M1 of the decoration 52 represents a “leaved-apple” figure with a concave shape. Four types of sheet pieces 61 to 64 shown in FIGS. 14B to 14E represent the entire pattern M1 formed of a combination of three partial patterns Q, R, and S when folded in a zigzag. Note that each of the sheet pieces 61 to 64 is composed of three sheet parts and is green on obverse and reverse faces. The partial pattern Q represents a “leaved apple,” and the partial pattern R represents an “apple.” Borders 70, 71, and 72 each represent an outline of the partial pattern S that has a shape in which four corners of a square are replaced with arcs (are rounded off).

The sheet pieces 61 to 64 according to the present second exemplary embodiment are different in a joining direction for the borders 70 to 72. Specifically, in the sheet piece 61 in FIG. 14B, a joining direction for the borders 70 to 72 is a Y-axis negative direction 400, as in the first exemplary embodiment. A joining direction for the borders 70 to 72 in the sheet piece 62 in FIG. 14C is a Y-axis positive direction 401; the sheet piece 63 in FIG. 14D, an X-axis negative direction 402; and the sheet piece 64 in FIG. 14E, an X-axis negative direction 403.

A direction orthogonal to any of line segments (four sides) which are linear parts of each of the borders 70 to 72 is designated as joining direction for the borders 70 to 72 by a control circuit 5 (step S41). For this reason, cutting data for folding, from which any of the sheet pieces 61 to 64 is obtained, is created in accordance with joining direction designation by the control circuit 5.

Ordinal positions in the overlapping order of the partial patterns Q, R, and S when each of the sheet pieces 61 to 64 is folded in layers are decided through step S12 that judges whether one partial pattern is included in a different partial pattern, as in the first exemplary embodiment. In each of the sheet pieces 61 to 64, TmpLapLine for the borders 70 to 72 of the partial patterns Q, R, and S are set in accordance with the decided ordinal positions (steps S45 to S47). The partial pattern R that has an even-numbered ordinal position in the overlapping order when each of the sheet pieces 61 to 64 is folded in layers is converted into a partial pattern which has a shape symmetrical with respect to TmpLapLine of the border 71 (step S48). Thus, the decoration 52 representing the same entire pattern M1 can be fabricated from any of the sheet pieces 61 to 64 by making a valley fold along a valley fold line 41 and a mountain fold along a mountain fold line 42 and folding, in layers, the sheet piece in a zigzag.

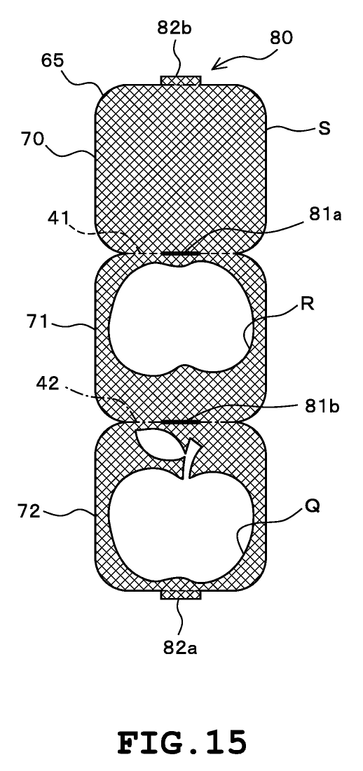

A sheet piece 65 according to the third exemplary embodiment shown in FIG. 15 is different from the sheet piece 62 in FIG. 14C in the following respects. Specifically, a holding unit 80 located in the vicinities of borders 70 to 72 for holding the sheet piece 65 in a folded state is provided at the sheet piece 65.

The holding unit 80 is composed of a slit 81 and a jutting part 82. More specifically, as shown in FIG. 15, the slit 81 is composed of a first slit 81a and a second slit 81b which are formed along the valley fold line 41 and the mountain fold line 42, respectively, and the jutting part 82 is composed of a first jutting part 82a and a second jutting part 82b which are formed at two end parts in a longitudinal direction of the sheet piece 65.

The first slit 81a is a linear incision which is obtained by changing a middle part, not including two end sides, of the valley fold line 41 into a normal cutting line. Similarly, the second slit 81b is a linear incision which is obtained by changing a middle part, not including two end sides, of the mountain fold line 42 into a normal cutting line.

The first jutting part 82a is formed jutting outward from the border 72 so as to correspond to a position of the first slit 81a when the sheet piece 65 is folded in layers in a zigzag. Similarly, the second jutting part 82b is formed jutting outward from the border 70 so as to correspond to a position of the second slit 81b when the sheet piece 65 is folded in layers in a zigzag.

That is, the first jutting part 82a is insertable into the first slit 81a, and the second jutting part 82b is insertable into the second slit 81b. Thus, the first jutting part 82a is inserted into the first slit 81a, and the second jutting part 82b is inserted into the second slit 81b while the sheet piece 65 is folded in layers in a zigzag. In this state, the sheet piece 65 is held folded in layers (see FIG. 14A). As described above, a decoration 52 is held in a completed state by the holding unit 80. At this time, the first and second jutting parts 82a and 82b fit in the first and second slits 81a and 81b, respectively, and are not exposed to the outside. Therefore, even if the holding unit 80 is provided, the outer appearance of the decoration 52 is not affected.

In the above-described cutting data creation program, after overlapping order is decided in step S4 and before cutting data for folding is created in step S5, a holding setting step for deciding the presence or absence of the slit 81 and the jutting part 82 is executed. With this execution, cutting data for folding for the sheet piece 65 including cutting line data for the slit 81 and the jutting part 82 is created (step S5). Note that since cutting line data for a border for the whole may be appropriately corrected to suit the shape of the jutting part 82, a detailed description of cutting line data for the jutting part 82 will be omitted.

As has been described above, a control circuit 5 according to the present third exemplary embodiment is configured as a holding setting section which executes the holding setting step of arranging the holding unit 80 in the vicinities of the borders 70 to 72. According to this configuration, cutting data for folding, from which the decoration 52 that is obtained by holding the sheet piece 65 folded in layers with the holding unit 80 in the vicinities of the borders 70 to 72 is obtained, can be created. Note that, in the holding unit, for example, the slit 81 may be omitted, glue or adhesive may be applied to the jutting part 82, and a state in which sheet parts are securely fixed may be held. Positions where the slit 81 and the jutting part 82 are provided, and the shapes, the sizes, and the numbers of the slit 81 and the jutting part 82 are not limited to those shown in FIG. 15 and may be appropriately changed in accordance with a sheet piece to be folded in layers.

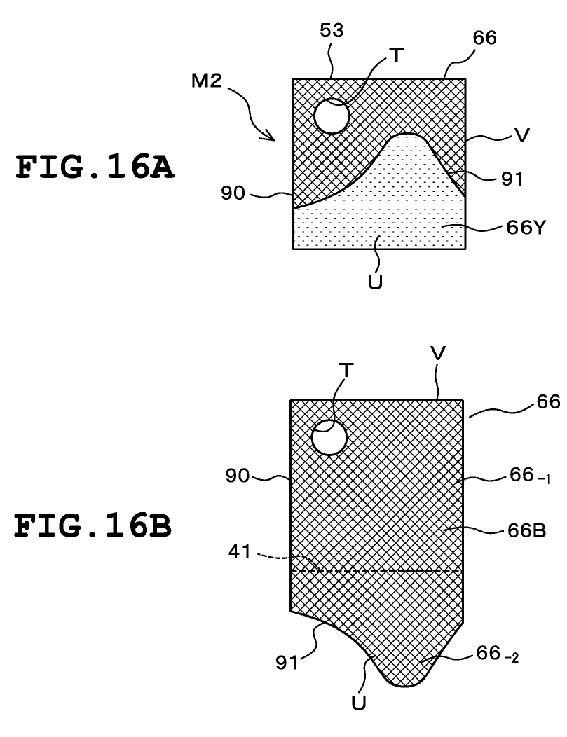

FIG. 16A shows a decoration 53 according to the fourth exemplary embodiment. An entire pattern M2 of the decoration 53 is formed of a combination of a partial pattern T representing a “full moon” with a concave shape, a partial pattern U representing a “mountain” with a convex shape, and a partial pattern V for a “peripheral area”.

A sheet piece 66 in FIG. 16B is a double-sided colored sheet of paper which is composed of two sheet parts 66₋₁ and 66₋₂ facing each other across a valley fold line 41 and has a blue obverse face 66B and a yellow reverse face 66Y (see FIG. 16A). A border 90 of the first sheet part 66₋₁ contains the partial pattern T, and a border 91 of the second sheet part 66₋₂ constitutes the whole of an outline of the partial pattern U. A base sheet part is omitted (see step S14 described above).

In the cutting data creation program described earlier, the ordinal positions in the overlapping order of the partial patterns T, U, and V when the sheet piece 66 is folded in layers is decided, TmpLapLine for the borders 90 and 91 is set, and symmetrical conversion of the shape of the partial pattern U, the ordinal position of which is even-numbered, is performed. As for the sheet piece 66 with the above-described configuration, the same effects as those of the first exemplary embodiment can be achieved by valley-folding the sheet piece 66 along the valley fold line 41 and folding the sheet piece 66 in layers. For example, a desired positional relationship between the “full moon” and the “mountain” (the relative positional relationship among the partial patterns T, U, and V) can be achieved.

The present disclosure is not limited to the above-described exemplary embodiments and may be modified or expanded in the following manner. A cutting data creation device may be configured as a so-called dedicated machine or the cutting device 11 provided with a cutting data creation function.

A recording medium having the above-described cutting data creation program recorded thereon is not limited to the external storage device 9 described above and may be one of various recording media, such as a USB memory, a CD-ROM, a flexible disk, a DVD, and a memory card. In this case, the same operation and effects as those in the exemplary embodiments can be achieved by causing a computer of one of various data processing devices to read and execute the program recorded on the recording medium.

In the embodiments described above, a single CPU may perform all of the processes. Nevertheless, the disclosure may not be limited to the specific embodiment thereof, and a plurality of CPUs, a special application specific integrated circuit (“ASIC”), or a combination of a CPU and an ASIC may be used to perform the processes.

The foregoing description and drawings are merely illustrative of the principles of the disclosure and are not to be construed in a limited sense. Various changes and modifications will become apparent to those of ordinary skill in the art. All such changes and modifications are seen to fall within the scope of the disclosure as defined by the appended claims.

What is claimed is:

1. A cutting data creation method for creating cutting data for fabricating a decoration representing an entire pattern formed of a combination of a plurality of partial patterns demarcated by borders by folding, in layers, a sheet cut in a shape having the linked partial patterns such that the sheet is partitioned into units demarcated by the borders, the cutting data creation method including:
setting a lap line for laying a part of the border of one of the partial patterns and a part of the border of a different one of the partial patterns on top of each other, for each of the two partial patterns;
joining the border of the one partial pattern and the border of the different partial pattern in a shape having the borders linked at the lap lines set in the setting; and
creating cutting data for cutting along the borders linked in the joining, except the lap lines.

2. The cutting data creation method according to claim 1, further including:
deciding ordinal positions in overlapping order of the plurality of partial patterns when the sheet is folded in layers, wherein
setting the lap lines of the borders of the partial patterns in accordance with the ordinal positions decided.

3. The cutting data creation method according to claim 1, further including:
converting one of the plurality of partial patterns, which has an even-numbered ordinal position in overlapping order when the sheet is folded in layers, into a partial pattern having a shape symmetrical with respect to the lap line of the border of the partial pattern.

4. The cutting data creation method according to claim 1, wherein the border contains the partial pattern or constitutes at least a part of an outline of the partial pattern.

5. The cutting data creation method according to claim 1, further including:
creating cutting data for a mark serving as an indicator of the folding using the lap line as a fold line position.

6. The cutting data creation method according to claim 5, wherein the mark is a line indicating the fold line position and includes a mountain fold line indicating that the sheet is to be mountain-folded along the mountain fold line and a valley fold line indicating that the sheet is to be valley-folded along the valley fold line, and the mountain fold line and the valley fold line are different in line type.

7. The cutting data creation method according to claim 1, further including:
designating a direction in which the borders are linked,
setting the lap line in accordance with the direction designated.

8. The cutting data creation method according to claim 1, further including:
arranging a holding unit for holding the sheet folded in layers in the vicinity of the border.

9. A cutting data creation device for creating cutting data for fabricating a decoration representing an entire pattern formed of a combination of a plurality of partial patterns demarcated by borders by folding, in layers, a sheet cut in a shape having the linked partial patterns such that the sheet is partitioned into units demarcated by the borders, the cutting data creation device comprising:
a controller,
the controller being configured to control the cutting data creation device to:
set a lap line for laying a part of the border of one of the partial patterns and a part of the border of a different one of the partial patterns on top of each other, for each of the two partial patterns;
join the border of the one partial pattern and the border of the different partial pattern in a shape having the borders linked at the lap lines set by setting; and
create cutting data for cutting along the borders linked by the joining, except the lap lines.

10. The cutting data creation device according to claim 9,
the controller being configured to further control the cutting data creation device to:
decide ordinal positions in overlapping order of the plurality of partial patterns when the sheet is folded in layers, wherein
set the lap lines of the borders of the partial patterns in accordance with the ordinal positions decided.

11. The cutting data creation device according to claim 9,
the controller being configured to further control the cutting data creation device to:
convert one of the plurality of partial patterns, which has an even-numbered ordinal position in overlapping order when the sheet is folded in layers, into a partial pattern having a shape symmetrical with respect to the lap line of the border of the partial pattern.

12. The cutting data creation device according to claim 9, wherein the border contains the partial pattern or constitutes at least a part of an outline of the partial pattern.

13. The cutting data creation device according to claim 9,
the controller being configured to further control the cutting data creation device to:
create cutting data for a mark serving as an indicator of the folding using the lap line as a fold line position.

14. The cutting data creation device according to claim 13, wherein the mark is a line indicating the fold line position and includes a mountain fold line indicating that the sheet is to be mountain-folded along the mountain fold line and a valley fold line indicating that the sheet is to be valley-folded along the valley fold line, and the mountain fold line and the valley fold line are different in line type.

15. The cutting data creation device according to claim 9,
the controller being configured to further control the cutting data creation device to:
designate a direction in which the borders are linked,
set the lap line in accordance with the direction designated.

16. The cutting data creation device according to claim 9,
the controller being configured to further control the cutting data creation device to:
arrange a holding section for holding the sheet folded in layers in the vicinity of the border.

17. A computer-readable recording medium storing instructions for a computer which has a controller,
the instructions cause, when executed by the controller, the computer to:
set a lap line for laying a part of the border of one of the partial patterns and a part of the border of a different one of the partial patterns on top of each other, for each of the two partial patterns;
join the border of the one partial pattern and the border of the different partial pattern in a shape having the borders linked at the lap lines set by setting; and
create cutting data for cutting along the borders linked by the joining, except the lap lines.
